(19) United States
(12) Patent Application Publication
(10) Pub. No.: US 2011/0169682 A1
(43) Pub. Date: Jul. 14, 2011

(54) LATERAL WAVE RADAR SYSTEM FOR FORWARD DETECTION

(75) Inventor: Chi-Chih Chen, Dublin, OH (US)

(73) Assignee: THE OHIO STATE UNIVERSITY RESEARCH FOUNDATION, Columbus, OH (US)

(21) Appl. No.: 13/059,371

(22) PCT Filed: Oct. 9, 2009
(86) PCT No.: PCT/US09/60274

§ 371 Date: Feb. 16, 2011

Related U.S. Application Data
(60) Provisional application No. 61/104,197, filed on Oct. 9, 2008.

(51) Int. Cl. G01S 13/88

(52) U.S. Cl. 342/21; 342/188; 342/22

(57) ABSTRACT

A forward-looking radar system adapted to detect and identify buried or near surface objects from a moving ground vehicle has been developed. The system incorporates a radar detection system and in one embodiment is mounted on a ground vehicle. The system is adapted to differentiate common roadway clutter from objects of interest.

### CROSS-REFERENCE TO RELATED APPLICATIONS

This non-provisional patent application claims the benefit of priority to U.S. Provisional Patent Application No. 61/104,197, filed on Oct. 9, 2008, which is hereby incorporated by reference in its entirety.

### TECHNICAL FIELD

The disclosed embodiments are in the field of radar detection, and more particularly in the field of radar detection of buried or near surface objects from a moving vehicle.

### BACKGROUND AND SUMMARY

Although downward-looking ground penetrating radars have been developed for detecting buried objects, they are not able to reliably detect buried objects close to the front of a moving vehicle or to detect the at a significant distance. Forward-looking radar prototypes have been developed for buried-object detection with horn antennas mounted on top of a vehicle as illustrated in FIG. 1. It was bulky and showed very limited success according published results. These antennas are typically tilted downwards at a certain depression angle to illuminate a patch of ground well ahead of the vehicle. Due to the vehicle's height limitation, an extended patch of ground is illuminated. This radar configuration should be effective in detecting surface targets (so do human eyes, IR sensors, etc.) or very shallow targets. For a slightly deeper target, this configuration becomes much less effective.

The propagation and scattering phenomenon associated with forward-looking detection of buried targets involves waves propagating in a two-layer or three-layer medium. In particular, the incident waves in such scenarios are close to grazing angle and excite lateral waves in addition to air waves and ground waves as illustrated in FIG. 2. Furthermore, roads in urban areas often contain multiple layers of pavements that may significantly affect the behavior incident and scattered fields. For instance, a high dielectric constant layer (such as asphalt) could become an effective waveguide that trap and guide electromagnetic energy along the layer especially when its thickness approaches a wavelength (in the medium). This could make detecting a perturbed area very effective. On the other hand, detecting a deeper target away from the layer may become ineffective. However, if the layer thickness less than one wavelength, it forms a leaky waveguide that serves to guide energy both inside and outside of the layer. This could be a very desirable configuration for forward detection of buried-objects since it does shed energy away as a lateral wave does. For bandwidth from 100 MHz to 1000 MHz, the wavelengths range from 200 cm to 20 cm. This implies that the surface layer could have all above properties.

Most early literatures on lateral waves studied radio waves propagate along earth crust. Expressions of lateral waves in two-layer and three-layer environment were derived. However, there is a lack of physical interpretation about actual wave mechanisms involved as no commercial embodiments employing lateral waves were developed.

When a transmitting antenna is positioned close to a dielectric half space (ground), ground waves (or G-waves) and lateral waves (or L-waves) are excited in addition to air waves (or A-waves) as illustrated in FIG. 3. Both airwaves and ground waves are spherical waves traveling at c (free-space velocity) and c/\sqrt{εᵣ} respectively. Lateral waves also travel at the speed of light along the surface but have conical wavefronts below ground. The amplitude of ground waves attenuates at the rate of e^{-αr}/r due to spherical expansion and ground absorption. The amplitude of lateral waves on ground surface attenuates as 1/ρ^{3/2} (: distance to source along surface) due to continuous shedding of electromagnetic energy into ground at the critical angle, θ_{c}.

The lateral wave arises from satisfying the wave boundary condition between two medium with different wave numbers when the wave in the less dense propagates along the interface. The propagation loss of lateral wave is greater than the normal cylindrical waves, 1/\sqrt{r}, or spherical waves, 1/r, due to continuous shedding energy away from surface into the denser medium at the critical angle. However, the amplitude attenuation of a lateral wave in a lossy ground is less than ground wave over a large distance since no material absorption is involved in the propagation of later waves. It should be noted that the propagation attenuation behavior of lateral waves on ground survey may change with the composition of the ground near surface.

If a short dipole is near a ground surface, its underground radiation pattern depends on the combination of ground waves and lateral waves. FIG. 4 shows a snapshot of electric field distribution of the H-plane (transverse to dipole axis) and E-plane (parallel to dipole axis) for an infinitesimal dipole located 10 cm above the surface of a lossless dielectric half space, These results were calculated using the commercial FEKKO simulation software based on method of moments. The relative permittivity and conductivity of the ground were assumed to be εᵣ=5 and σ=0 S/m, respectively. Since FEKKO performs simulation at a fixed frequency at a time, these time-domain data were synthesized from frequency data calculated from 400 MHz to 1200 GHz at 20 MHz steps. These results indicate the presence of both space waves and lateral waves in ground. They travel at different speed and interfere with each other to produce the composite antenna radiation patterns in frequency domain. Both air waves and ground waves have spherical wavefronts. The lateral waves can be identified by the linear phase front which is inclined at the critical angle (θ_{c}=26.5°) from the interface as indicated in the figure. In three dimensions, lateral waves spread out conically and are caused by energy refracting into the subsurface at the critical angle. This conical wavefront begins at the tangent circle on ground wave and ends at surface where it is connected to air waves.

The physical interpretation of the above snap shot is shown in FIG. 5. The lateral waves play a role of connecting the initial wavefronts between air waves and ground waves since they propagate at the different phase velocity but are excited at the same time initially from the source. The matching of wavefront of the ground space wave is obtained by the evanescent wave in the air. The lateral wave and evanescent wave can be observed for angles wider than the critical angles when a source is close to the surface.

The presence of ground can significantly modify an antenna's radiation patterns. For instance, the approximate far-field of an infinitesimal dipole antenna at a height of h above a half-space are expressed as

$$\begin{matrix} {E}_{θ}^{ground} = {ω}^{2} {μ}_{0} {k}_{12} p \vert cos θ \vert {e}^{- j {k}_{2} h \sqrt{1 - {k}_{12}^{2} {sin}^{2} θ}} \cdot {T}_{‖} ( {k}_{12} ) \frac{{e}^{- j {k}_{1} r}}{4 π r} & ( 1 ) \\ {E}_{φ}^{ground} = {ω}^{2} {μ}_{0} {k}_{12} p \vert cos θ \vert {e}^{- j {k}_{2} h \sqrt{1 - {k}_{12}^{2} {sin}^{2} θ}} \cdot {T}_{⊥} ( {k}_{12} ) \frac{{e}^{- j {k}_{1} r}}{4 π r} \sqrt{1 - {k}_{12}^{2} {sin}^{2} θ} & ( 2 )\end{matrix}$$

where k₁ and k₂ are the ground and air wave numbers, respectively, k₁₂=(1/k₂₁)=k₁/k₂, T (k₁₂) is the perpendicular-mode ground-air transmission coefficient

$${T}_{⊥} ( {k}_{12} ) = \frac{2 \sqrt{{k}_{12}^{2} - {sin}^{2} θ}}{\vert cos θ \vert + \sqrt{{k}_{21}^{2} - {sin}^{2} θ}} \qquad ( 3 )$$

and T_{∥} (k₁₂) is the paralle-mode dielectric-air transmission coefficient

$${T}_{‖} ( {k}_{12} ) = \frac{2 {k}_{21} \sqrt{{k}_{12}^{2} - {sin}^{2} θ}}{{k}_{21}^{2} \vert cos θ \vert + \sqrt{{k}_{21}^{2} - {sin}^{2} θ}} \qquad ( 4 )$$

However, in most subsurface sensing applications, the above far-field expressions are not applicable since most targets of interest are not in the far field and the medium is not simple. In these cases, numerical modeling techniques are often the only means to predict near-field radiation patterns which vary with frequency and distance due to frequency-dependent ground properties and interference between ground waves and lateral waves. For instance, FIG. 6 compares the near-field distributions of a surface short dipole antenna at 250 MHz on a lossless ground with two different dielectric constants: 9 and 15. The ground surface is located at z=0 position. The left and right figures correspond to E and H plane, respectively. These field distributions clearly different from far-field patterns and vary with distance and are different between E and H planes. FIG. 7 plots the magnitude of an electromagnetic pulse observed at 1-meter distance from the source for three different ground dielectric constants: 4, 9 and 15. From these normalized field distribution, one can see that the radiation towards the air decreases as the dielectric constant increases (to be discussed in more details shortly). Similarly, FIG. 8 compares the near-field magnitude distributions at 250 MHz when two different conductivity values (0.01 S/m and 0.1 S/m) are introduced to the ground with a dielectric constant of 9. As expected, the field magnitude attenuates as distance increases due to ground absorption. As the conductivity increases, the attenuation rate also increases. Special attention should be paid to the relatively strong field magnitude associated with lateral waves near the air-ground interface as indicated in the dotted line. This is because lateral waves are not subject to the ground attenuation.

In summary, a forward-looking radar system adapted to detect and identify buried or near surface objects from a moving ground vehicle has been developed. The system incorporates a radar detection system and in one embodiment is mounted on a ground vehicle. The system is adapted to differentiate common roadway clutter from objects of interest.

### BRIEF DESCRIPTION OF THE DRAWINGS

FIG. 1 is a conventional radar configuration in forward detection.

FIG. 2 depicts an embodiment of a novel radar concept that utilizes forward propagating lateral waves for forward detection of a shallowly buried anomaly.

FIG. 3 illlustrates different wave mechanisms excited from a source close to ground surface.

FIG. 4 is a snapshot of the field radiated by an infinitesimal dipole 10 cm above an air-ground interface (εr=5, σ=0 S/m), simulated by FEKO.

FIG. 5 is a physical interpretation: Air space wave, Ground space wave, Lateral wave, and evanescent wave.

FIG. 6 shows near-field distributions (at 250 MHz) for a short dipole on the surface of a lossless ground with dielectric constant of 9 (top) and 15 (bottom), respectively.

FIG. 7 shows near-field radiation observed at one-meter distance from a short dipole antenna located on the surface of a lossless ground.

FIG. 8 shows the near-field distributions (at 250 MHz) for a short dipole antenna on the surface of a lossy ground with a relative permittivity of 9 and conductivities of 0.01 S/m (top) and 0.1 S/m (middle), respectively.

FIG. 9 shows normalized far-field radiation patterns for an infinitesimally small dipole positioned at four different heights above the surface of a lossless ground (εᵣ=5).

FIG. 10 illustrates the air and ground wave radiated from a source elevated from the ground placed at a certain height.

FIG. 11 illustrates the ratio of field magnitude along the vertical axis as a function of antenna height.

FIG. 12 shows the input impedances of half wavelength dipole (wire diameter=2 mm) at different height above the lossless ground. (εᵣ=15 and σ=0 S/m).

FIG. 13 shows the input impedances of half wavelength dipole (wire diameter=2 mm) at different height above the lossy ground. (a) εᵣ=15 and σ=0.1 S/m (b) εᵣ=15 and σ=1 S/m

FIG. 14 shows the resonant frequency shift ratio as a function of height with different ground properties.

FIG. 15 shows the FDTD Model setup for investigating forward detection of buried targets.

FIG. 16 includes snapshots of incident fields for source height of (top) 45 cm (middle) 25 cm (bottom) 0 cm.

FIG. 17 shows peak amplitude of the EM pulse shown I, FIG. 16 on ground surface.

FIG. 18 shows incident fields at forward position (10-feet distance) below the ground surface (12-inches depth) in a ground. Source height at (a) 0 cm (b) 25 cm (c) 45 cm.

FIG. 19 includes snapshots of scattered electrical fields from a buried object for source height of (top) 45 cm (middle) 25 cm (bottom) 0 cm.

FIG. 20 includes snapshots of scattered electrical fields at source height of (top) 45 cm (middle) 25 cm (bottom) 0 cm.

FIG. 21 shows pulsed scattered fields from a buried 105 mm with different source heights and a higher refractive index top layer.

FIG. 22 shows resistively loaded Vee antenna on ground.

FIG. 23 shows a comparison of far-field radiation pattern (E-plane) of a resistively loaded vee antenna and a short dipole.

FIG. 24 shows realized gain of lateral waves (along the critical angle direction) in FIG. 22 configuration for three different depression angles with the ground dielectric constant being 9.

FIG. 25 shows realized gain of lateral waves (along the critical angle direction) in FIG. 22 configuration for three different flare angles with the ground dielectric constant being 9.

FIG. 26 shows measured responses (background partially removed) of elongated conducting target buried 1-inch below surface in a sandy medium.

FIG. 27 shows measured backscattered responses from shallowly buried conducting elongated target from a horizontally polarized ridged horn antenna (in picture) positioned 2-foot above sandy ground.

FIG. 28 is a comparison of raw data and background removed data for the 2-foot pipe located at 10 feet and 13 feet away from antenna.

FIG. 29 is a comparison of co-polarization and cross-polarization responses (background removed) from the 2-foot long pipe located 10 feet away from antenna.

FIG. 30 shows measured responses from a pair of sand covered #20 conducting wires at 10 feet and 13 feet away from antenna.

FIG. 31 shows potential antenna locations for an embodiment of a radar detection system.

FIG. 32 shows a Logarithmic-Horn antenna.

FIG. 33 shows the Logarithmic-Horn simulated antenna gain and pattern.

FIG. 34 shows the Log-Horn simulated E-plane antenna gain and pattern.

FIG. 35 shows the Log-Horn simulated & measured reflection coefficient.

FIG. 36 shows a 10 deg feed Log-Horn simulated antenna gain and pattern.

FIG. 37 shows a 10 deg feed Log-Horn simulated E-plane antenna gain and pattern.

FIG. 38 illustrates a 10 deg Log-Horn simulated & measured reflection coefficient.

FIG. 39 illustrates a 10 deg feed Log-Horn measured reflection coefficient reduction.

FIG. 40 shows embodiments of both a Vivaldi antenna single element and multiple element array.

FIG. 41 shows the Vivaldi antenna element simulated reflection coefficient.

FIG. 42 shows the Vivaldi antenna measured reflection coefficient.

FIG. 43 shows the Vivaldi antenna measured E-plane antenna gain and pattern.

FIG. 44 shows the Vivaldi measured H-plane antenna gain and pattern.

FIG. 45 is a set of pictures of selected roadway impediments.

FIG. 46 depicts objects made of a series connection of small parallel plates.

FIG. 47 illustrates an object made of two parallel saw blades

FIG. 48 shows an object made of two long parallel conducting plates in an enclosure.

FIG. 49 illustrates the FEKO simulation parameters for one object

FIG. 50 shows the results for the Big Saw and Cylinder RCS numerical analysis.

FIG. 51 illustrates a vertically polarized incident plane wave at different source heights.

FIG. 52 illustrates a horizontally polarized incident plane wave at different source heights.

FIG. 53 shows the Big Saw incident angle RCS numerical analysis.

FIG. 54 depicts the Big Saw RCS numerical analysis for polarization.

FIG. 55 shows the FEKO simulation physical layout.

FIG. 56 shows the FEKO simulation of RCS resonance from H-H or V-V waves.

FIG. 57 is a schematic of an embodiment of a prototype radar system.

FIG. 58 illustrates an embodiment of a radar antenna.

FIG. 59 depicts the test range configuration.

FIG. 60 shows the Measured Data: Black Hose.

FIG. 61 shows the Measured Data: Small Saw.

FIG. 62 shows the Measured Data: Big Saw.

FIG. 63 shows the Measured Data: Many Hoses.

FIG. 64 shows the Measured Data: Hose Strip on Wood.

FIG. 65 shows the Test Setup: Multiple Object Discrimination.

FIG. 66 shows the Measurement Data: Integration.

FIG. 67 illustrates a Resonant Signature Extraction data.

FIG. 68 shows additional Resonant Signature Extraction data.

FIG. 69 shows further Resonant Signature Extraction data.

FIG. 70 is a picture of an asphalt measurement set-up.

FIG. 71 shows migration data.

FIG. 72 shows an example EM resonance extraction algorithm.

FIG. 73 shows data for an object detection experiment.

FIG. 74 shows data for an object detection experiment.

FIG. 75 includes a block diagram and an embodiment of a vehicle mounted radar system.

FIG. 76 depicts early and later embodiments of antenna array designs.

FIG. 77 shows the simulated realized gain for a 13-element Vivaldi array

FIG. 78 shows data from a 13-element Vivaldi-type array.

FIG. 78 shows data from a 13-element Vivaldi-type array measured H-plane pattern.

FIG. 79 shows data from H-plane normalized gain for a 13-element array.

FIG. 80 shows data from car responses at different distances.

### EXAMPLES

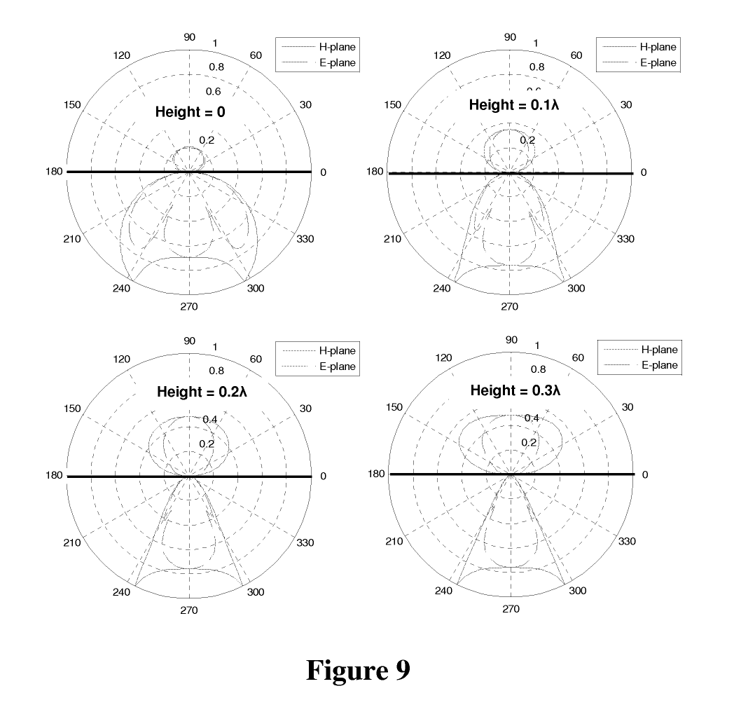

The radiation power and radiation pattern from a small dipole located on or near ground surface were examined. FIG. 9 shows the calculated far-field radiation patterns at 100 MHz for a short dipole antenna positioned at different antenna heights above a ground characterized by εᵣ=5 and σ=0 S/m. Below the ground, ground waves dominate radiation within a solid cone angle defined by the critical angle (θ_{c}=26.5°). Radiation beyond the critical angle is dominated by lateral waves. These results reveal that elevating an antenna's height causes reduction in lateral wave excitations and results in radiation mainly confined within the solid cone. This finding suggests that the antenna height should be kept less than 1/10 of wavelength in order to excite strong lateral waves.

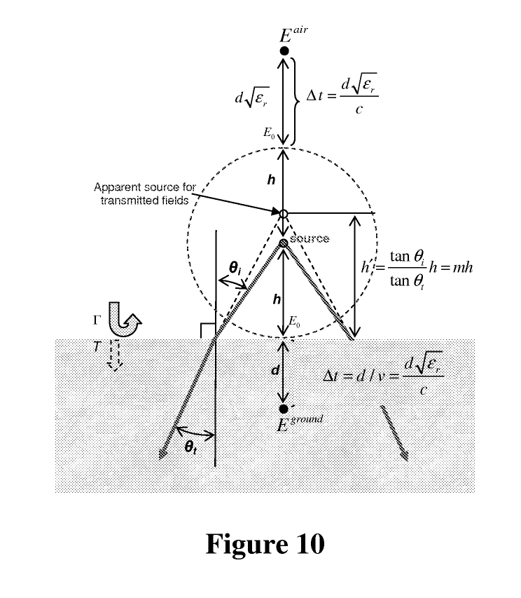

It is a well know phenomenon in ground penetrating radar applications that more electromagnetic energy is coupled into ground when the antenna is close to ground. This phenomenon can be quantitatively described by comparing the magnitude of the ground waves and air waves on the vertical axis. Assuming a point source is placed at a height of h above a lossless ground with a dielectric constant of εᵣ as illustrated in FIG. 10. The resultant air wave consists of a direct wave from the antenna and waves reflected back from ground surface as expressed by

E^{air}=E_{D}^{air}+E_{R}^{air} (5)

where E_{D}^{air} and E_{R}^{air} represent, respectively, the direct wave and reflected wave. At the position z=h+\sqrt{εᵣ}d above the source, the direct wave and reflected wave can be expressed as

$$\begin{matrix}{E}_{D}^{air} = {E}_{0} \frac{h}{h + \sqrt{{ɛ}_{r}} d} {e}^{- j {k}_{0} ( \sqrt{{ɛ}_{r}} d )} & ( 6 ) \\ {E}_{R}^{air} = Γ {E}_{0} \frac{h}{2 h + ( h + \sqrt{{ɛ}_{r}} d )} {e}^{- j {k}_{0} ( 2 h + \sqrt{{ɛ}_{r}} d )} & ( 7 )\end{matrix}$$

where Γ is the reflection coefficient and kₒ is the free-space wave number; E₀ is the field at z=±h. The fractions in these equations account for wave spreading. The z=h+\sqrt{εᵣ}d observation distance is chosen based on the same propagation time as the ground wave reach a depth of d. Similarly, in the simplest case when the incident angle is zero, the corresponding ground wave is expressed as

$${E}^{ground} = {TE}_{0} \frac{h}{h + d} {e}^{- j {k}_{r} d} \qquad ( 8 )$$

where T is the transmission coefficient from air into the ground; kᵣ is the ground wave number; d is the depth of the observation point on the z-axis. Note that the apparent height (h′) accounts for the refraction effect (See FIG. 10). From the above, the ground wave to air wave ratio becomes

$$\frac{{E}^{ground}}{{E}^{air}} = \frac{\frac{T}{( h + \frac{d}{\sqrt{{ɛ}_{r}}} )}}{\frac{1}{( h + \sqrt{{ɛ}_{r}} d )} + \frac{Γ {e}^{- j 2 {k}_{0} h}}{( 3 h + \sqrt{{ɛ}_{r}} d )}} , \qquad ( 9 )$$

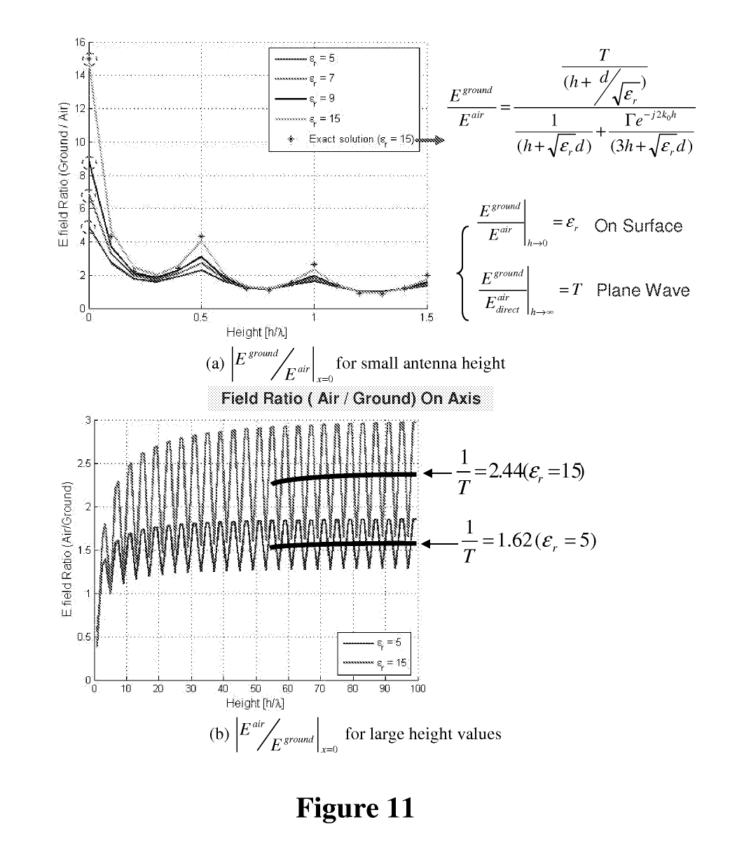

FIG. 11 plots the magnitude of (9) as a function of antenna height for several different dielectric constants (5, 7, 9, and 15). FIG. 11(a) shows the ground/air ratio for smaller height range whereas Figure (b) shows air/ground ratio for a greater height range. It is observed that the ground/air ratio approaches the value of εᵣ when antenna is on surface (h=0). This ratio decreases as antenna height increases until the incident waves become similar to plane waves and the air/ground ratio approaches to 1/T as expected (see FIG. 11(b)).

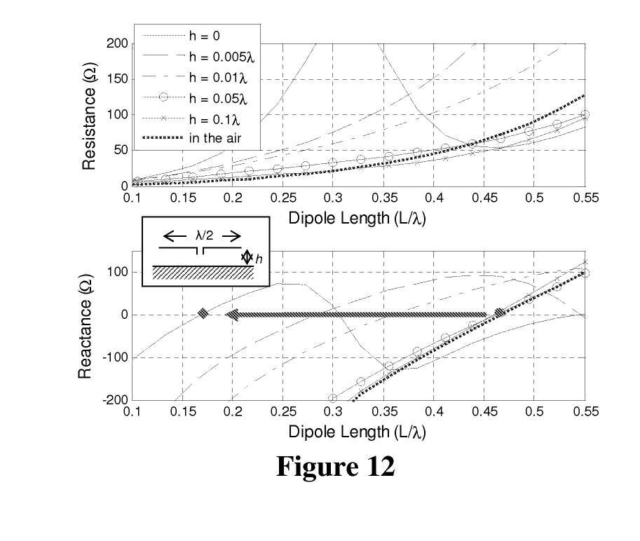

The presence of ground also affects the antenna impedance especially when the antenna is close to ground. For example, FIG. 12 shows calculated input impedance of a half wavelength dipole antenna for different antenna heights. The wire diameter of the dipole is 2 mm. The dielectric constant and conductivity of the ground is 5 and 0 S/m, respectively. The impedance obtained in the absence of the ground is also plotted for comparison. These results indicate that that the input impedance begins to deviate significantly from its free-space value when the height is less than 0.1λ. As antenna height approaches zero, the electrical length of the antenna increases due to dielectric loading effect and causes the resonant frequency to shift toward a lower frequency. When an antenna is placed directly on the surface, the current velocity along the antenna is slowed down by the effective dielectric constant expressed as

$${ɛ}_{e} = \frac{1 + {ɛ}_{r}}{2} \qquad ( 10 )$$

As expected, elevating the antenna height would cause the effective dielectric constant moves toward the free space value. In FIG. 12, the first resonance of the dipole in the air occurs around 0.47λ indicated by circle marker, while the first resonant of the dipole on the ground surface occurs around 0.27λ indicated by diamond marker. This shifting agrees well with the factor of \sqrt{εᵣ} predicted from (10) for εᵣ=15.

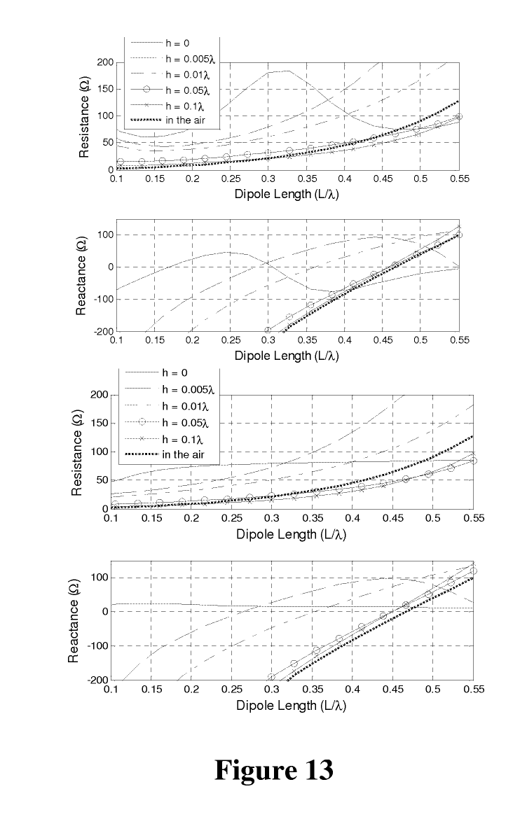

FIG. 13 plot the similar result as in FIG. 12 except that loss is introduced to the ground by adding a conductivity of (a) σ=0.1 S/m and (b)σ=1 S/m, respectively. It is observed in FIG. 13(a) that the input resistance at low frequency increases compared to FIG. 12 for the same height. This is due to additional conduction loss in ground. In FIG. 13(b), the input impedance shows almost constant behavior over the frequency range, seemly an ultra wide bandwidth antenna. However, this is because most energy is consumed by the ground with high conductivity. That is the ground resistance dominate the overall antenna resistance (greater than radiation resistance).

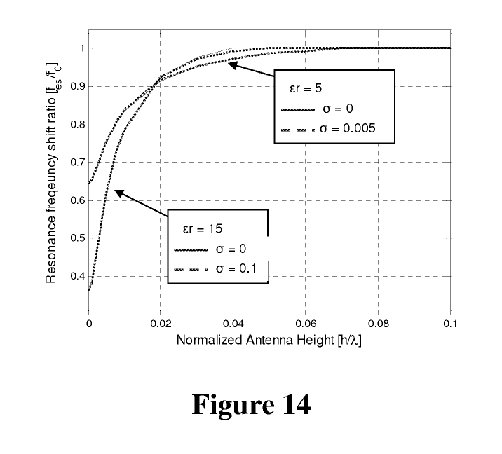

In summary, the presence of ground definitely affects the input impedance of an antenna whose height is less than 0.1λ₀. FIG. 14 plots the ratio of the resonant frequency shift with respect to the resonant frequency obtained in the absence of ground. The resonance shift ratio moves from 1/\sqrt{εᵣ} to one, as the height increases.

The characteristics of an antenna located near a ground (a lossy dielectric half-space) can be affected by the electrical property of the ground results indicate that the antenna impedance begins to deviate from its free-space value when the antenna height is less than 1/20 of wavelength and approached a half-space loading value when the antenna is directly placed on surface (see FIG. 12 and FIG. 13). The amount of electromagnetic energy coupled into the ground also depends on the ground property and antenna height. We found that the magnitude ratio of ground wave to air wave on the vertical axial significantly increases when the antenna height is less than a quarter of wavelength and approach a value of εᵣ as height decreases to zero (FIG. 11). Such a relation can be completely described by the reflection, transmission and refraction phenomenon. The radiation pattern in the air is determined by the directed and reflected waves. The radiation pattern in ground is far more complicated due to interference between the ground wave and lateral wave. As a result, the pattern in the ground varies with position and frequency.

The finite-difference time-domain (FDTD) modeling technique was utilized to gain a better understanding of propagation and scattering phenomenon associated with forward detection of a shallowly buried object. The FDTD technique is known to be advantageous in modeling UWB signals and complex environments. We first conducted numerical simulations to study excitation and propagation of different wave mechanisms. Then we investigate the behavior of scattered fields from 105 mm object buried at 30-cm depth. The ground is assumed to be either homogeneous or have a top dielectric layer whose dielectric constant could be higher or lower than that of the bottom layer.

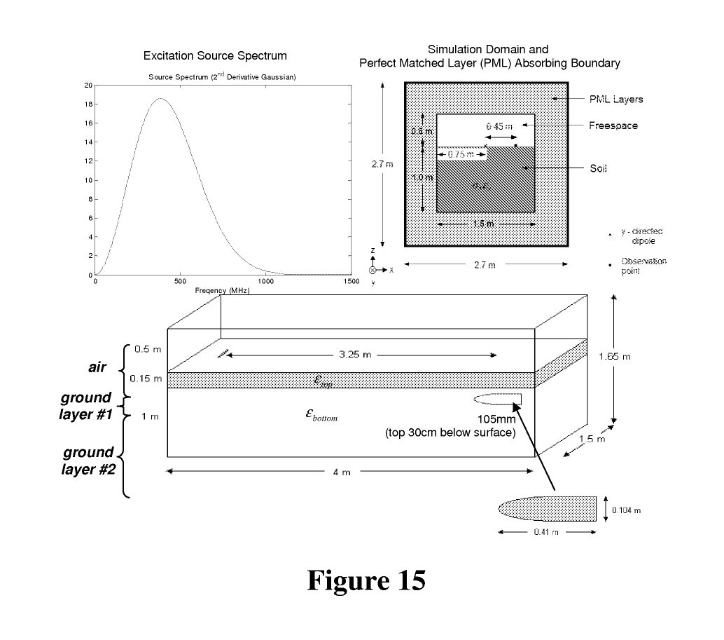

FIG. 15 shows the typical model configuration adopted for our simulations. The excitation source is a short electric dipole, oriented perpendicularly to the paper, excited by a derivative Gaussian pulse. The height of the dipole varies in different cases. The spectrum of this pulse is shown in the upper left of FIG. 15. A perfectly matched layer (PML) is placed around the simulation domain as shown in the upper right corner of FIG. 15 to reduce reflections caused by the truncation of the model. The ground half space used in the model includes a top layer which is assumed to be horizontal and 15 cm in thickness (see FIG. 15). The dielectric constant of the top layer could be higher or lower than that of the ground. This inclusion of this top layer is to simulate paved road scenarios. Then, a conducting target resembles the shape of a 105 mm object (see FIG. 15) was placed 30 cm below surface for scattering study. The target is laid horizontal (i.e. parallel to ground surface) with its orientation being either parallel or perpendicular to the down range direction, i.e. direction of travel.

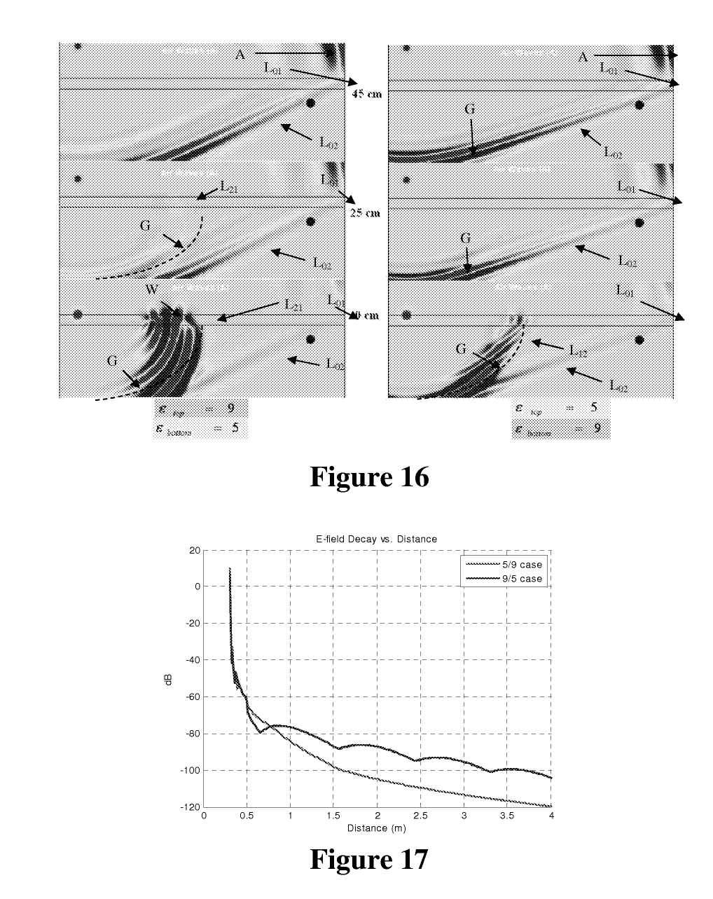

FIG. 16 plots snapshots of electromagnetic fields propagating away from a short dipole (left of the figure) positioned at three different heights: 0 cm (bottom figures), 25 cm (middle figures), and 45 cm (top figures), respectively. Left figures correspond to high-contrast top layer with the dielectric constants of the ground and the top layer to be 5 and 9 (i.e. 9/5 case), respectively. The opposite case (i.e. 5/9 case) is shown in right figures. Labels are added to indicate different wave mechanisms.

There are air wave (or A-wave), ground wave (or G-wave), the lateral waves (L-wave). There are three possible lateral waves L₀₂, L₁₂, L₂₁ where the first subscript indicates the medium containing the incident fields and the second subscript indicates the medium containing the lateral wave. Note that lateral wave only exists when the dielectric constant of the second medium is higher with a large incident angle. Also, L₀₁ is not important here due to the relative thin thickness. When the dielectric constant of the top layer is higher than that of the ground, it forms a dielectric slab waveguide and guides an additional wave (therefore referred as W-wave). The A-wave is clearly visible and expands outwards from the source with a spherical wavefront. As discussed in Section 2.2, the A-wave gets stronger as the source is raised from surface and gradually settles down to a constant average value as shown in FIG. 11(b). The G-wave also has a spherical wavefront. As expected, G-wave becomes a little weaker when the source is elevated. All lateral waves can be identified by the conical wavefront (appear as long linear wavefront in FIG. 16) which is connected to the A-wave at ground surface. The continuity between L-wave and A-wave implies that the L-wave also gets a little stronger as the antenna is slightly raised above the ground surface. Notice the presence of strong W-wave when there is a high-contrast (against ground) top layer. If the electrical thickness is sufficiently large, waves can be guided very effectively along the layer. However, W waves can only be excited effectively when the source is very close to surface.

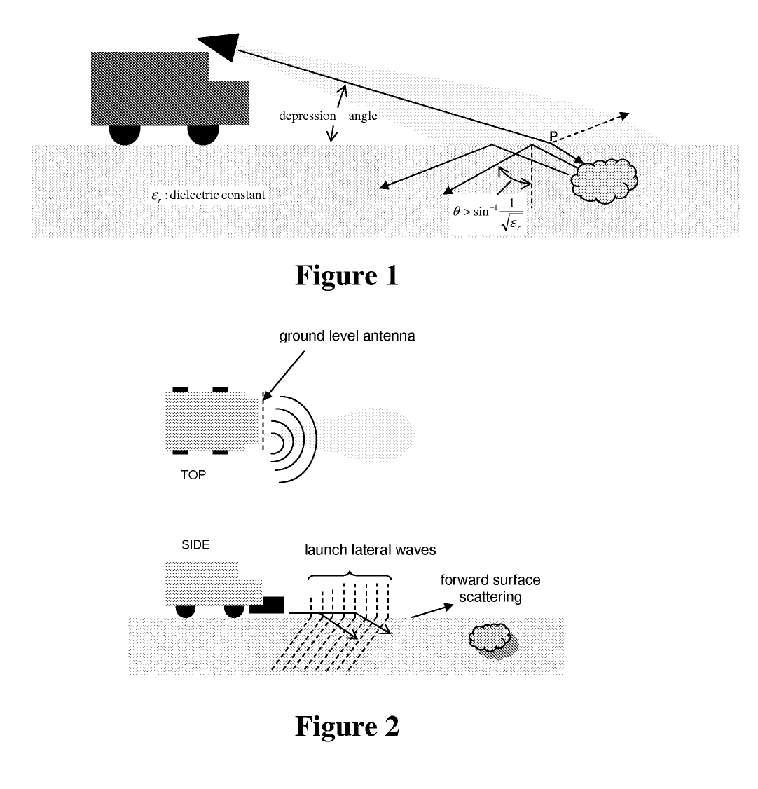

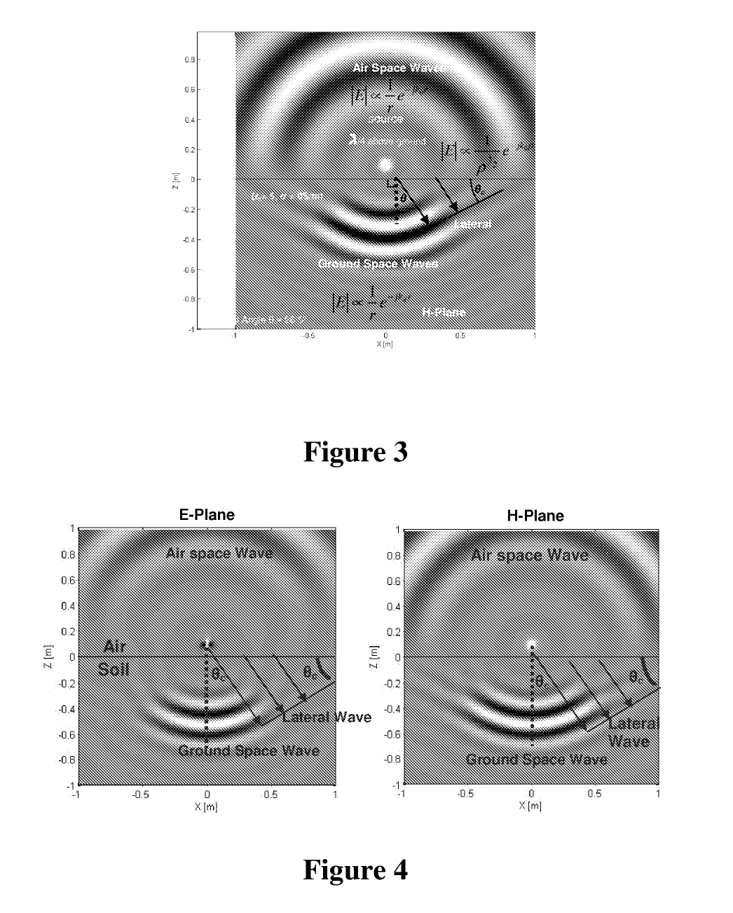

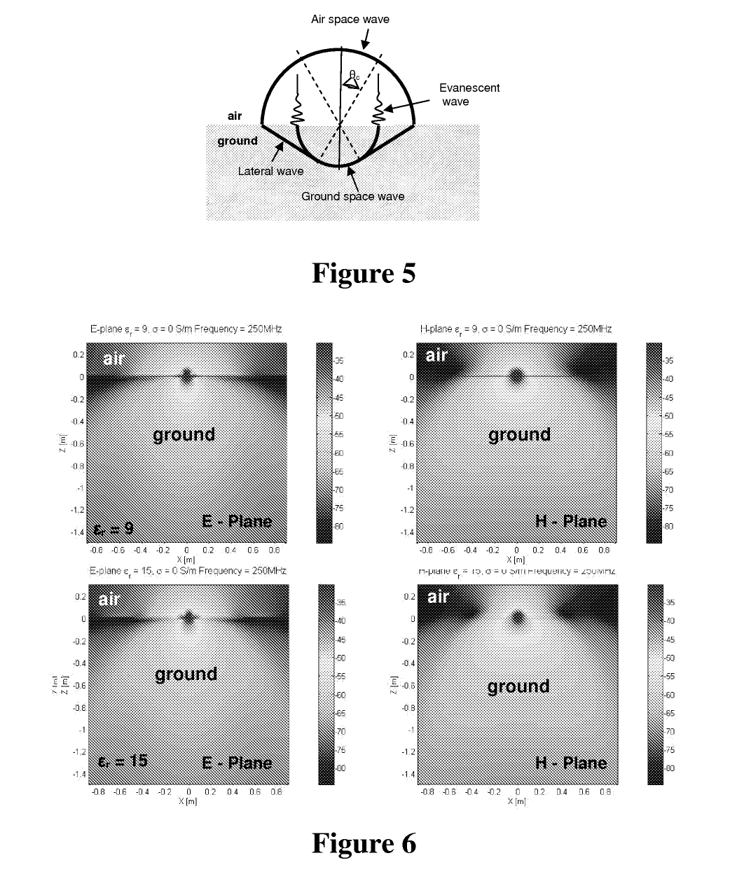

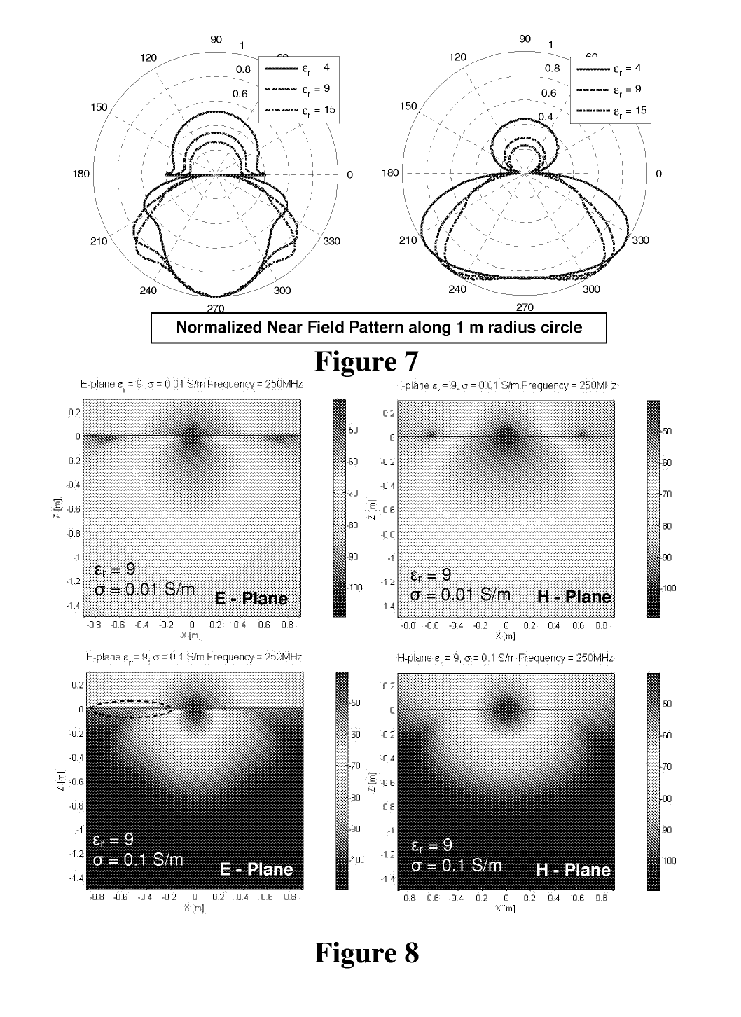

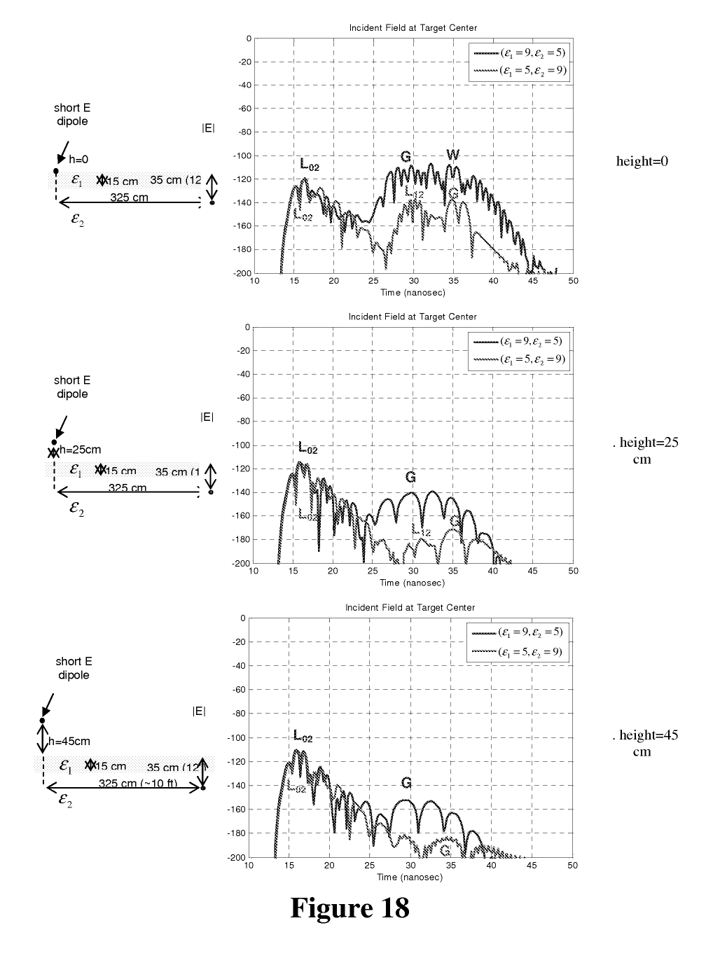

FIG. 18 plots the magnitude (in dB) of EM fields observed at the intended target location as a function of time. Since the observation point is located below the top layer and in the vicinity of the top layer, only L-wave, W-wave and G-wave could be observed. Labels are added to indicate different wave mechanisms. In all cases, L₀₂ wave arrives first since it travels at free-space speed. As discussed previously, the magnitude of L₀₂-wave increases slightly as the source is raised from surface due to increasing A-wave. When the source is placed on the surface of a high-contrast top layer (i.e. 9/5 case), G-wave arrives next and is followed by the W-wave which is guided the highest dielectric layer. In the low-contrast top layer case, the L₀₂-wave is followed by the L₁₂-wave (lateral wave in layer two excited by wave propagating in layer one) and then the G-wave. The magnitude of G-wave decreases rapidly as transmitter's height increases. Such reduction is more rapid than observed along vertical axis (see FIG. 1) due to addition pattern narrowing caused by refraction. As expected, the arrival time of G-wave depends on the dielectric of the bottom medium. This explains why the G-wave in the 5/9 case arrives later than that in the 9/5 case. In the late-time region, the high-contrast top layer, i.e. 9/5 case, produces much stronger incident fields compared to the case with a low-contrast top layer (or 5/9 case). The incident fields in the latter case are far too weak to be used for detection unless the source is located on surface. It is clear from these results that the transmitting source should be kept very close to surface whenever there is a high-contrast top layer present to take advantage of the waveguide phenomenon. These results indicate that the later wave dominates the incident field in almost all cases.

In such a three-layer (air, top(1) and bottom (2)) configuration, the propagation loss is different from the usual 1/ρ^{3/2} factor for the half-space case. FIG. 17 plots the peak amplitude of the EM pulse shown in FIG. 16 on ground surface as a function of distance from the source.

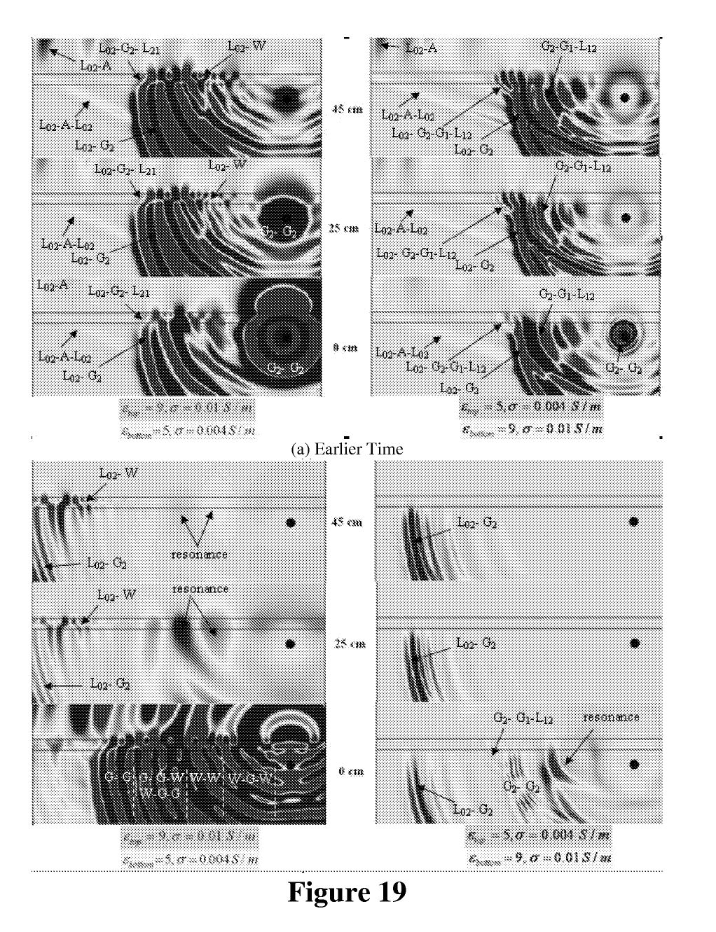

Now, let's examine the scattered fields from a buried 105 mm object excited by the incident fields discussed in the previous section. FIG. 19 plots the snapshots of scattered fields from a 105 mm object buried at 30-cm depth (from top of the object). The object is oriented perpendicularly to the incident plane. The incident fields have been removed by subtraction out the fields calculated in the absence of the object. The color scale was adjusted (different from FIG. 16) to enhance the visibility of the scattered fields. However, all figures in FIG. 19 share the same color scale (red indicates positive polarity and blue indicates negative polarity). The snapshots were taken at two different time instants with FIG. 19(a) being at an earlier time and FIG. 19(b) being at a later time. Again, three different source heights (0 cm, 25 cm and 45 cm) and two different ground conditions (9/5 and 5/9) are included. The left figures shows results for a ground with a dielectric constant of 5 and conductivity of 0.004 S/m (similar to dray sand) with a 30cm-thick top layer characterized by dielectric constant of 9 and conductivity of 0.01 S/m. Results for the reversed case are shown to the right.

In the previous section, we observed up to three different types of incident waves impinging upon the target. Each wave type could cause scattered fields which could propagate into air (A-wave) via refraction, along the top layer via total reflection, or directly into the bottom medium (i.e. G-wave). The scattered field that propagates along any of the dielectric interface can subsequently excite lateral wave in the high-contrast side of medium. To help understanding different wave mechanisms of the scattered fields, we labels each wave mechanism as “xxx-xxx” or “xxx-xxx-xxx”. The first “xxx” indicates the wave type of incident wave and the last “xxx” indicates the wave type of final scattered wave. Some label has on or more middle “xxx” to indicate the type intermediate wave(s) involved. For instance, the “L₀₂-A-L₀₂” indicates the incoming L₀₂ wave causes scattering from target into air (i.e. A-wave) via refractions. The A-wave component that propagates along the surface then subsequently excites the L₀₂ wave. The same incident L₀₂-wave also causes scattered fields that propagate completely in the bottom medium, i.e. G-wave.

If the receiver is elevated from surface, the dominant scattered field is resulted from “L₀₂-A” mechanism. That is, the L₀₂ incident wave is scattered from target into air via refraction. If the receiver is located very close to the surface, the dominant scattered field is resulted from L₂₁ lateral waves excited from lateral wave (L₀₂) or ground wave (G), or (in the case of high-contrast top layer) waveguide wave (W) excited from L₀₂, G or W incident waves.

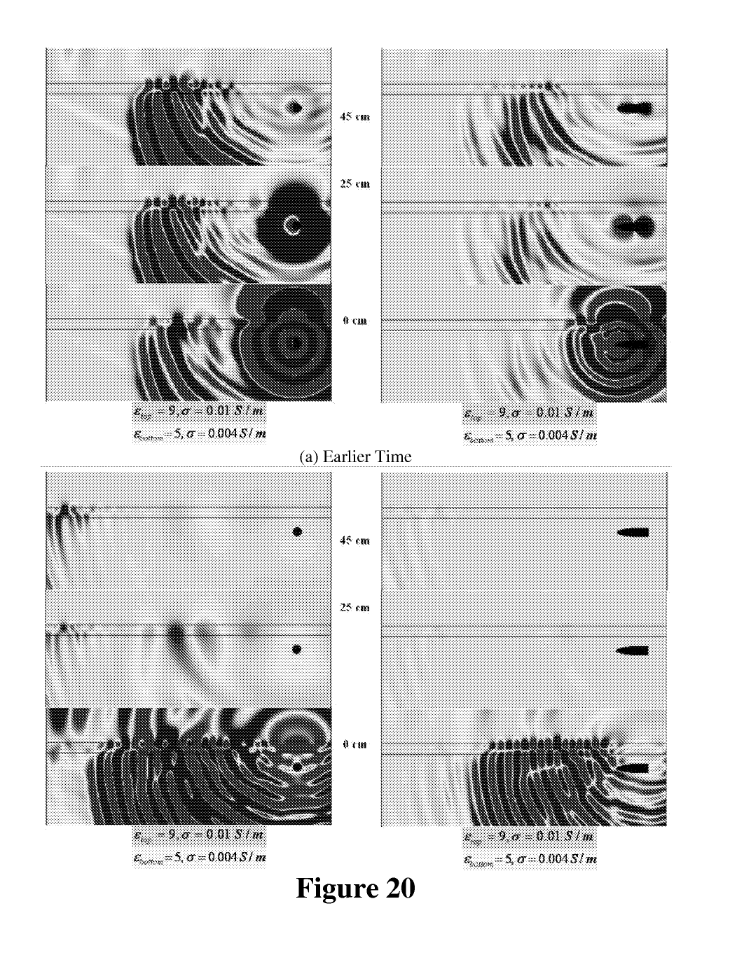

At later time, i.e. FIG. 19(b), the perpendicular object shows significant electromagnetic resonant fields propagating along ground surface in the case of high-contrast top layer (i.e. 9/5 case). Such resonance is very weak when the object is oriented parallel to the travel direction as illustrated in FIG. 20 even in the presence of the high-contrast top layer. The scattered fields caused by W-wave and G-wave incident waves dominate late-time responses. However, only the high-contrast top layer case with transmitter located closed to surface produces strong A-wave that can be detected by an elevated receiver.

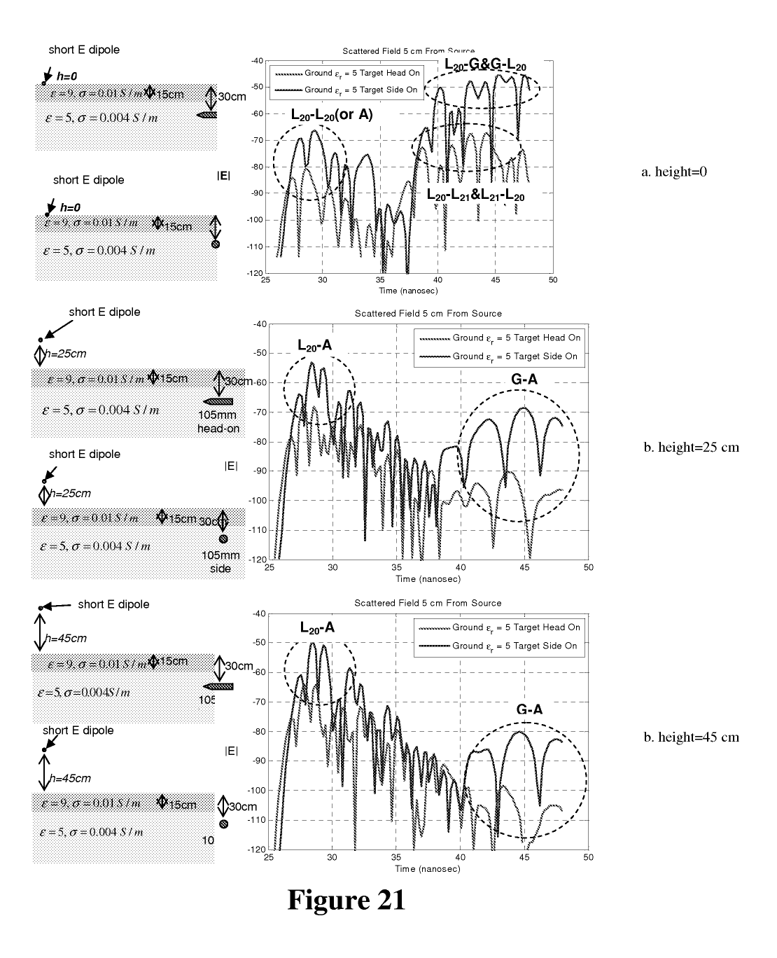

FIG. 20 compares similar snapshots of scattering fields between parallel (left) and perpendicular (right) object orientations in the case of high-contrast top layer. A perpendicular object produces stronger scattered fields than a parallel object does. The scattered fields from the parallel orientation case is approximately 15˜20 dB weaker. This is clearer from in FIG. 21 where the magnitude of fields received at the same location of the transmitter is plotted as a function of time.

Lateral waves play a key role in the forward detection of buried target. The incident and scattered fields associated with lateral waves dominate the responses in almost all cases that were investigated. The only exception was when the transmitter was positioned very close to the ground containing a high-dielectric top layer. Such top layer effectively traps and guides electromagnetic waves, thus increasing the magnitude of incident and backscattered fields.

If the ground does not have a high-dielectric top layer, slightly elevating the transmitter and receiver can result in a stronger (up to 17 dB at 45 cm) response associated with “L₀₂-L₀₂” mechanism. It should be noted that too much height will result in a blind region near the transceiver due to pattern effect if a directive antenna is used and is aimed toward horizontal. The greater the height, the larger the bind spot. Although, strategically aiming the antenna downwards slightly may alleviate some of this problem, it will likely reduce the maximum detection range as well.

In the presence of a high dielectric pavement, stronger incident fields can be achieved by placing the transmitter very close to the ground to excite the waveguide mode (W-wave). Much stronger late-time responses associated with the L₂₁ mode can also be picked up using a receiver very close to ground. Another interesting effect of this high-dielectric top layer is that it enhances the electromagnetic resonance of the object which is buried beneath the layer. Such enhancement is attributed to the reflections at the bottom of the high-dielectric layer and bounces much of the scattered field back to the object. Of course, it is questionable whether a disturbed layer caused by the burial of the object will have a similar enhancement.

An appropriate antenna suitable for forward detection should be directive and has an ultra-wide bandwidth. Since the antenna is likely to be mounted on vehicle, it is also desirable for the antenna to be low cost and compact in size. The initial frequency range of this antenna in this study was chosen to be from 100 MHz to 1000 MHz based on a reasonable trade off between range resolution, ground penetration and target classification. Note that the compact-size requirement also limits the maximum achievable directivity. A good directivity is essential to minimize radiation upwards into sky and downwards into ground. It also maximizes radiation towards forward direction to increase the signal to noise ratio and detection range. FEKKO software numerical simulations were employed for calculating antenna configurations.

The simplest and compact UWB antenna design that has been adopted widely in ground penetrating radars is a resistively loaded dipole. However, such antenna has a broad radiation pattern and low efficiency. To increase the directivity, one can use the resistively loaded V-antenna.

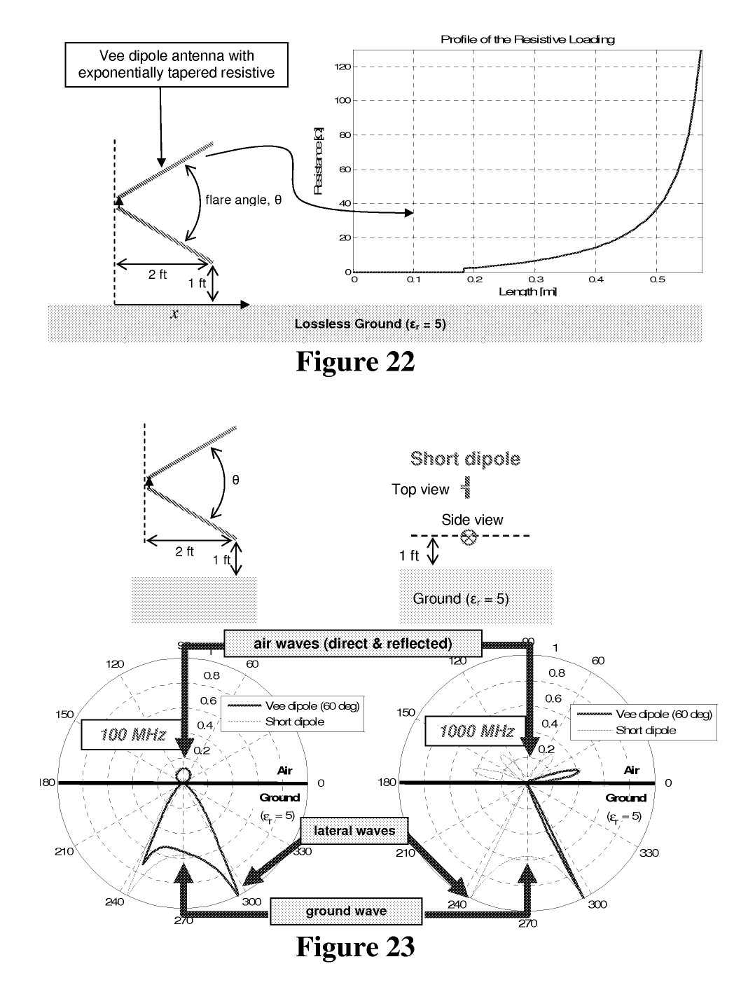

A V-antenna contains two straight thin conducting arms formed in a shape of “V” with a certain flare angle as illustrated in FIG. 22. Each conducting arm is connected to a resistive section whose resistance value increases gradually to attenuate the current on the antenna arm to reduce end diffractions, and thus achieving a broader bandwidth. The upper right figure shows the adopted tapering profile of resistance that is exponentially increased from 3 ohm to 127 ohms along the 1-foot long section. The total length of each antenna arm is 2 feet. The final antenna is placed one foot (from the lowest part of the antenna to ground) above a lossless dielectric ground with a dielectric constant of 5. FIG. 23 compares the resultant normalized (against the maximum value) E-plane far-field patterns radiated from the resistively loaded V-antenna and that from a short dipole (also one-foot above ground). The patterns for the short dipole and the V-antenna are shown in red and blue, respectively. The left graph corresponds to patterns taken at 100 MHz and the right graph corresponds to patterns taken at 1000 MHz. The two peaks in the ground occur at the critical angle (˜26.6 degrees from vertical direction) and are caused by lateral waves. These patterns indicate that V-antenna generates much less ground wave and most lateral waves toward the front. At 1000 MHz, only a forward lateral wave is excited from the V-antenna due to the narrower pattern at high frequencies.

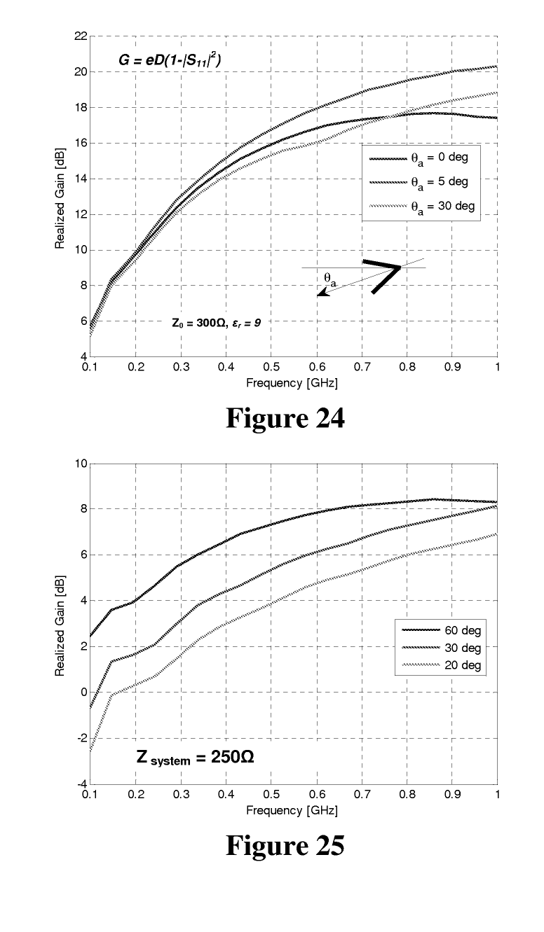

It is known that the excitation of lateral waves is related to the incident angle and magnitude of incident fields on surface. For a given radiation pattern, tilting antenna changes the fields illuminating on the surface and thus changes the excitation of lateral waves. FIG. 24 plots the realized gain associated with lateral waves (i.e. taken along critical angle directions, ˜19.5 degrees from vertical) for three different depression angles. These results were obtained in a similar environment shown FIG. 22 except that the ground dielectric constant is changed to 9. As one can see, a slight gain increase (˜2 dB) is observed when the antenna is tilted slightly downwards (i.e. depression angle of approximately 5 degrees). However, too much tilting causes lateral-wave gain to decrease and ground-wave gain to increase. Such a small gain increase does not warrant the need to tilt the antenna as it might sacrifice maximum detection range.

FIG. 25 plots the realized gain associated with lateral waves for three different flare angles. These results were obtained in environment shown in FIG. 22 but the ground dielectric constant is changed to 9. It is observed that the gain level monotonically increases as the flare angle increases from 20 degrees to 60 degrees. This is due to better impedance matching to the system impedance (250 ohms in our case). Note that increasing flare angle results in higher antenna impedance.

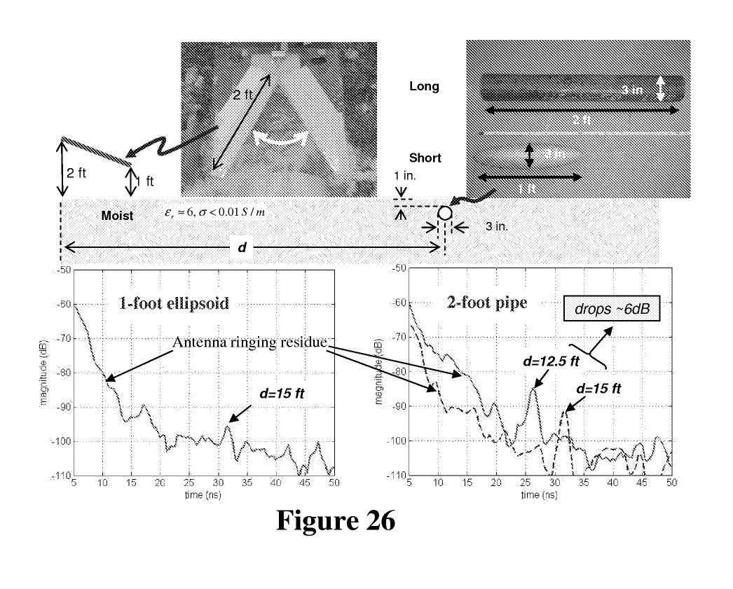

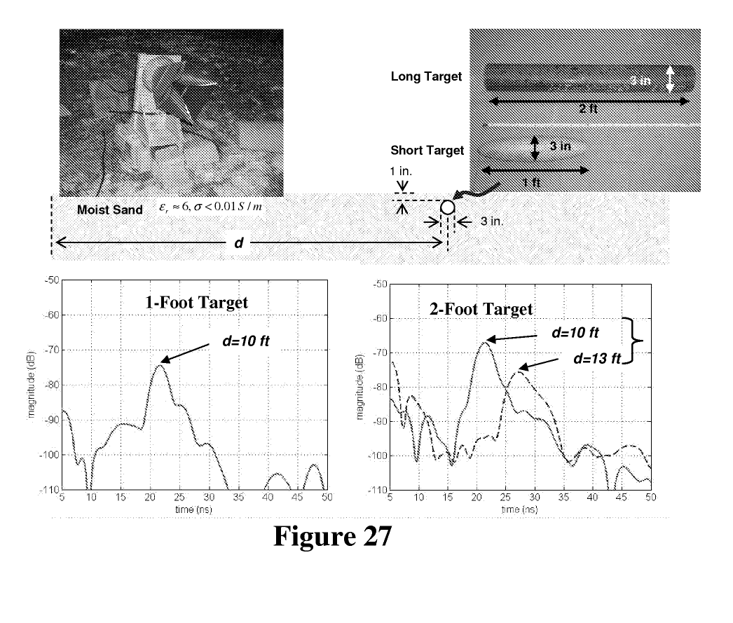

In addition to above analytical study, we also carried out experimental study to gain additional information from actual measured data. These experiments involved measuring mono-static backscattering response of an elongated conducting target that was shallowly buried (1 inch below surface) at a distance ranging from 10 to 20 feet from the antenna. Two targets were selected for these experiments and are shown in FIG. 26. The first one was a 2-foot long steel pipe with a diameter of 3 inches and thickness of 0.5 inches. The second target was a 1-foot long aluminum ellipsoid with a length of 12 inches and a diameter of 3 inches. The soil was moist sandy clay with estimated dielectric constant and conductivity of around 6 and 0.01 s/m. Two antennas were used in these experiments. The first one was a planar V-antenna as shown in FIG. 26. The second one was a commercial quad-ridge antenna shown in FIG. 27. The V-antenna was tilted downward such that the feed point and the end point were 2 feet and 1 foot above around, respectively. The data were collected using a vector network analyzer in step-frequency mode from 30 MHz to 1000 MHz. The results shown here are in the time domain obtained from transforming the windowed frequency-domain data using the inverse Fourier transform.

The measured response of the 1-foot ellipsoid located 15 feet away from the antenna is shown in the lower left graph of FIG. 26. This result was obtained with most background subtracted out accept for some residual antenna ringing left due to antenna structure change caused by blowing wind. The response peak of the target is observed at approximately 32 ns position as indicated in the figure. Its peak level is approximately −96 dB with respect to the antenna's input power, +5 dBm (not accepted power). The responses from the 2-foot pipe located at 12.5 feet and 15 feet from the antenna are shown in the lower right graph where the peaks associated with the pipe responses are also indicated. The pipe buried at the same distance produces approximately 5 dB stronger response compared to the ellipsoid due its larger size. The pipe response drops approximately 6 dB as distance increases from 12.5 feet to 15 feet.

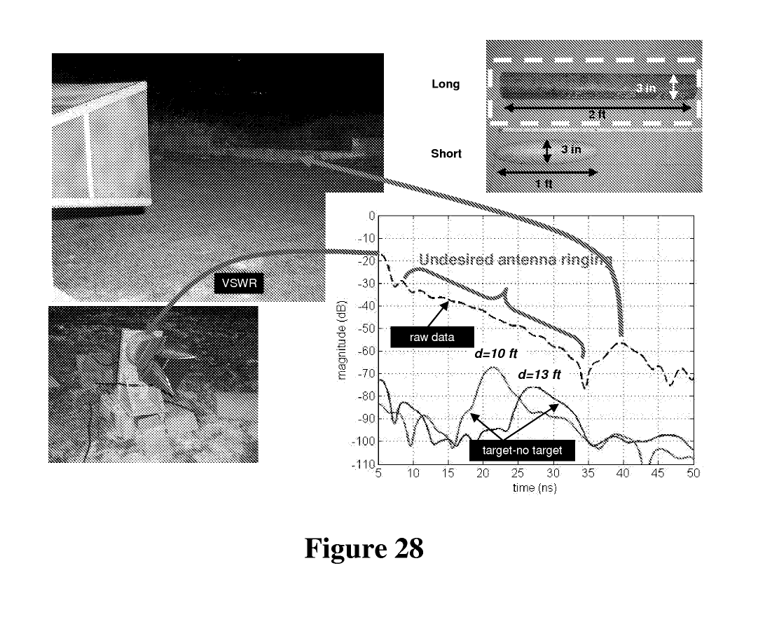

FIG. 27 shows the measured results of similar setup except that a commercial quad-ridge horn antenna was used. Since this antenna is more rigid, a better subtraction is achieved and the result shows much less antenna ringing residue and lower background level after background subtraction. If the background is not removed, the responses would be dominated by the antenna mismatch term and ringing as shown in FIG. 28. The target response increases by about 10 dB compared to the previous results using the V-antenna. These results clearly demonstrate that a properly chosen antenna design could enhance the detection capability.

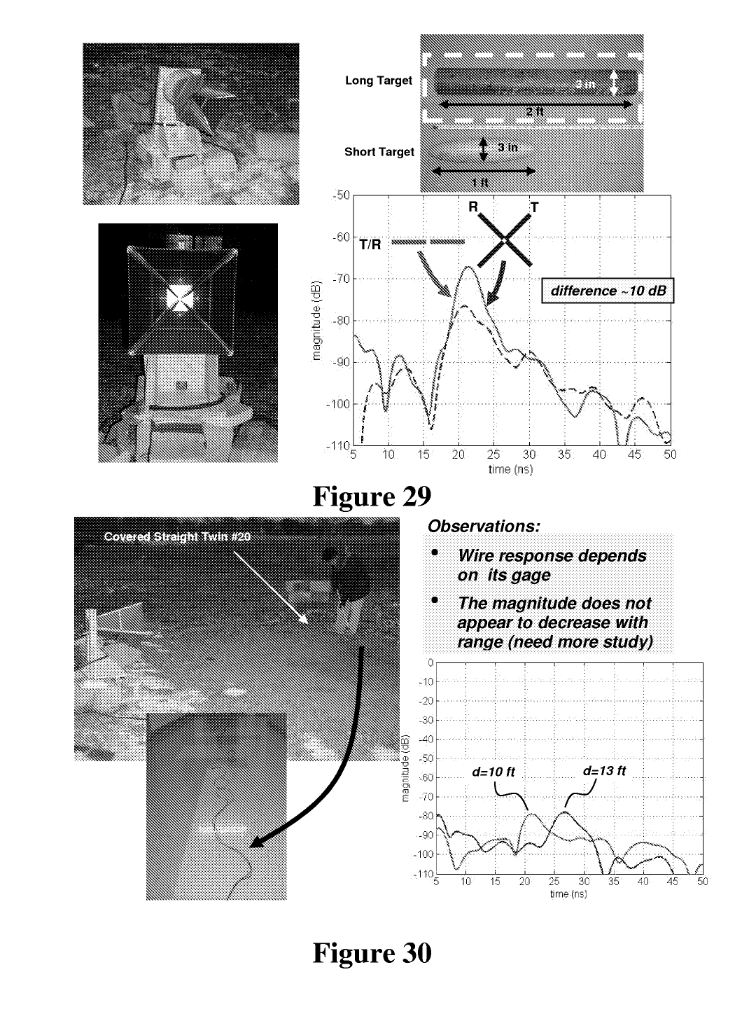

It is sometimes useful to measure cross-polarization responses since it has lower antenna clutter level and is not sensitive to reflection from a large flat object. FIG. 29 compares the co-polarization and cross-polarization responses of the 2-foot pipes buried at a distance of 10 feet. FIG. 29 shows the experiment setup and measured responses using co-polarization (horizontal-horizontal) and cross-polarization configurations as shown in the pictures. The 2-foot pipe was used as the target placed at 10 feet distance from the antenna. As one can see, the cross-polarization response is approximately 10 dB lower the co-polarization response. This is more than the 6 dB drop based on polarization along. The additional 4 dB difference is likely due to the pattern effect since the target is not on the antenna axis and this antenna has different E-plane and H-plane patterns.

[symbol]

A pair of #20 wires was placed transverse to the direction of travel at a distance of 10 and 13 feet, respectively. The wires were simply covered with minimal amount of sand so that it is invisible. The co-polarization data (horizontal-horizontal) were collected. The background removed responses are plotted in FIG. 30. At 10-foot distance, the wire response is weaker then the responses from previous two targets due wire's small cross sectional area. However, it is interesting to observe that, unlike previous targets, the wire response does not seem to decrease as the distance is increased from 10 to 13 feet. This may be related to the extended length of the wires. However, the exact cause of this phenomenon needs to be further investigated.

The design specifications for the radar system's antennas are derived from the physical limitations of mounting on a moving vehicle, and the optimal performance within those limitations.

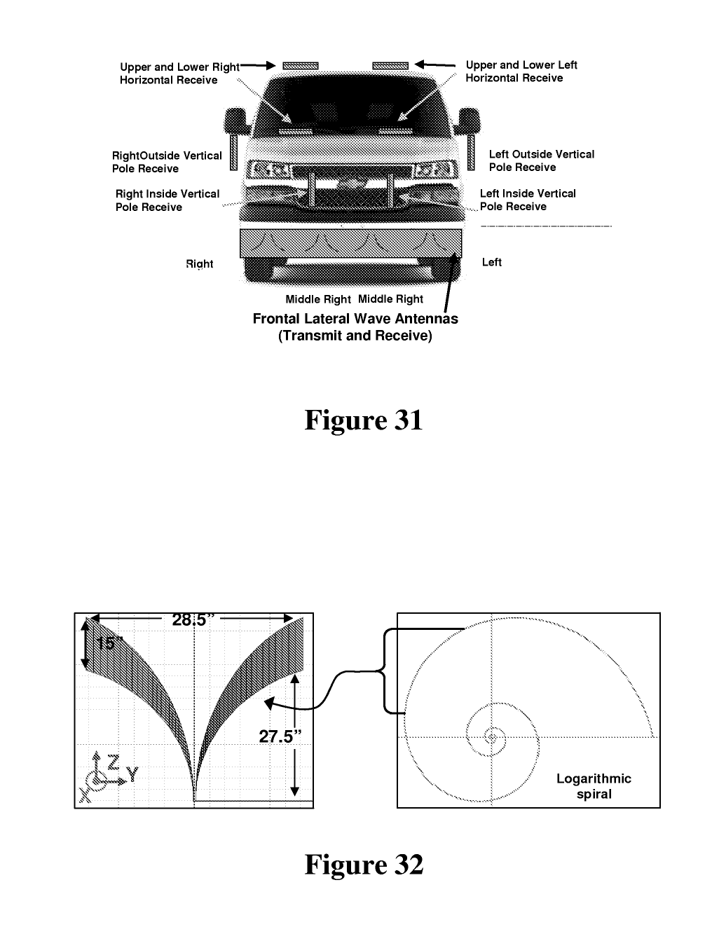

The antennas designed must be easily mounted to a vehicle and not interfere with the operator's ability to safely maneuver the vehicle at traveling speeds. FIG. 31 shows a variety of likely positions for vehicular mounting. The antennas should be available for mounting so that the phase center of the antenna is within 1-3 feet from the ground. Particularly large antennas will also be difficult to mount so that the physical effects of vibration will not adversely affect the performance of the antennas. In general, all designed antennas should have horizontal and vertical measurements less than 24 inches. FIG. 1 shows the exception that along the bumper of the vehicle, an antenna or array of antennas may stretch the entire horizontal dimension of a vehicle.

Antenna Gain across the radar spectrum should be in all cases above 0 dB and in the range of 7-10 dB for as much of the frequency range as possible. Commercially available horn antennas have a desirable constant gain for reasonable wide bandwidths, but can be very large when lower frequencies are desired.

Since the vehicle will be moving forward or stationary at all times, the area of interest is directly in front of the vehicle. Along roadway travel, it is important to illuminate the road in front of the vehicle and several feet on either side of the road. The main area of interest is 100-300 feet in front of the vehicle and from the roadway surface to 6 feet underground. These constraints identify an antenna with a beam angle of 20-30 degrees in the vertical dimension and 45-60 degrees in the horizontal dimension.

It is desirable that the antennas have a constant radiation pattern for all measured frequencies so that any objects are equally detectable and their location is discernable. It is important that very little energy be transmitted into a back lobe of the antenna toward the vehicle.

For detection and classification of buried and surface objects information from many frequencies will be helpful. This creates another challenge for antenna design. An ultra-wide bandwidth antenna in the range 300-6000 MHz is desired. It is possible that different antennas could meet different sub bands within this range; however, a single antenna with very little shift of phase center over the entire frequency range is desirable.

It is desirable for the antenna to be matched to be fed by a 100 ohm feed. This requirement will enable the majority of the transmitting RF circuitry to be developed using off-the-shelf components. Especially at higher transmitting power levels, custom components can be unnecessarily expensive and less reliable. Again, it is ideal if the impedance is well matched across the entire bandwidth of the antenna.

For some of the preliminary testing; two antennas have been used. AEL 1734 gain standard horn and an ETS double-ridged horn. The AEL horn provides a linear polarization and the ETS horn provides the capability of using a linearly polarized mode, or using two orthogonal, linearly polarized portions simultaneously.

The AEL horn has a very reliable bore sight gain of +10 dB from 600 (MHz) to 6000 (MHz). Below 600 (MHz), the gain drops off quickly. At 400 (MHz) the gain is +2.7 dB, but for 300 (MHz) and 200 (MHz) the gain is −5.4 dB and −20 dB respectively. The frequencies to be used in the final design are still being investigated. Frequencies lower than 400 (MHz) may require physically large antennas, but may also be instrumental in detecting and discriminating objects at or near the roadway surface. The ETS horn has similar gain performance to the AEL.

Well-designed horn antennas generally provide wide a wide band antenna with a predictable pattern for the frequencies of interest. Horn antennas are relatively easily manufactured, and can be re-produced with repeatable electromagnetic properties. The two plates of the horn antenna can be tapered to create a frequency-independent geometry across the operational bandwidth of the antenna. A design was proposed as shown and described in FIG. 32.

To find a natural growth rate, which promotes the frequency independence of the antenna, a curvature along the Y-Z axis was inspired by the logarithmic spiral defined by:

r=ae^{bθ}

Rewritten in parametric form:

Y(t)=ae^{bt} cos(t)

Z(t)=ae^{bt} sin(t)

The model was simulated in HFSS, and the proportions were optimized to give an acceptable gain and relatively constant far-field pattern while also fitting the physical restraints of vehicle mounting. The design concentration was on the frequency range 200 MHz-1000 MHz. After several iterations, the design as shown in FIG. 2 was defined using the following equations and duplicating the structure on the opposite side of the Z-axis:

Y(t)=−13.5e^{t/π} cos(t)+14.1896+0.125 [in]

Z(t)=21.5e^{t/π} sin(t)−7.3426 [in]

0.1π≦t≦0.5π

The constants added to the set of equations bring the tangent points of the two halves of the horn to the meet at the origin to provide a feed location for the horn. The additional Y-dimension shift of 0.125 (in) is implemented to create a 0.25 (in) gap between the two plates of the horn at the antenna feed.

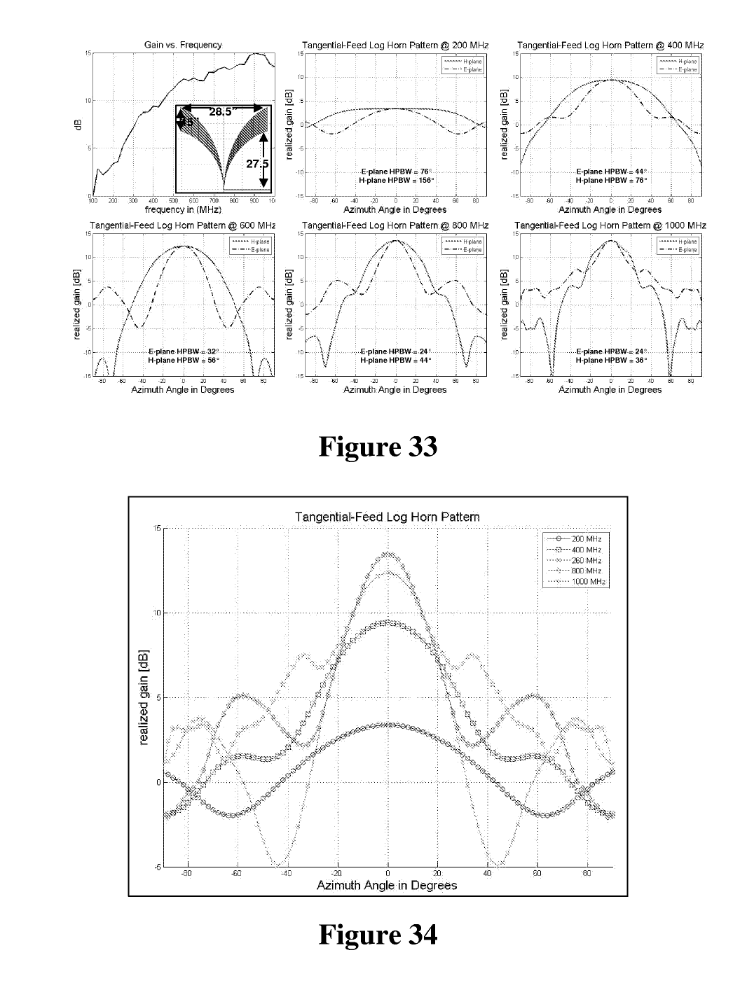

The X-dimension, as shown in FIG. 2, was defined by using a 15° plate angle from the feed location to the extremities of each arm. The software simulated realized gain and pattern within the specified frequency range are shown in FIG. 33.

At frequencies above 500 (MHz), the E-plane (vertical dimension when mounted) HPBW remains reasonably constant between 24°-32°. Side lobes are present with gain between −7 to −10 dB. The H-plane HPBW varies from 36°-56°, and in all cases, the side-lobes are depressed at least −15 dB below the peak gain. At frequencies below 500 (MHz), the pattern is significantly broader. In the E-plane, side-lobes are almost non-existent at 400 (MHz), while the H-plane exhibits no side lobes in the in the forward facing half-plane. Below 400 (MHz) the pattern is broader than desired, but the peak gain level of +3 dB shows that an acceptable amount of energy is being transmitted in the direction of potentially detectable objects while. Since the beam width is wider than desired, additional false alarm objects may be illuminated by the low-frequency radiation and will have to be considered when the data is processed. FIG. 34 shows the superimposed E-plane pattern for each of the five frequencies selected to give an understanding of how well this antenna would discriminate between objects in the desired range and those outside that range.

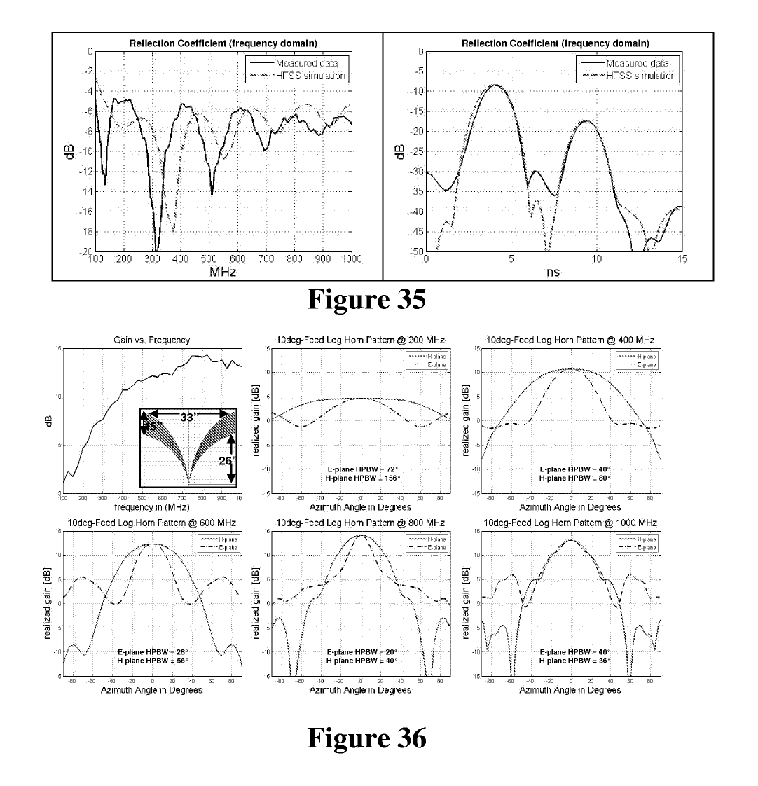

The antenna discussed was then constructed using a wooden frame and shaped copper sheets. A M/A Com 30-3000 (MHz) 0-180° hybrid was used as a balun to feed the antenna from a 50Ω coaxial feed from a vector network analyzer. The initial study of the reflection coefficient of this antenna shown in FIG. 35 gave unacceptable results. The measured matched the simulated data very closely, but showed that the antenna was simply not well matched through most of the frequency range. The time-domain view showed that the reflection at the antenna feed and the end of the horn were very large, −8 and −17 dB respectively.

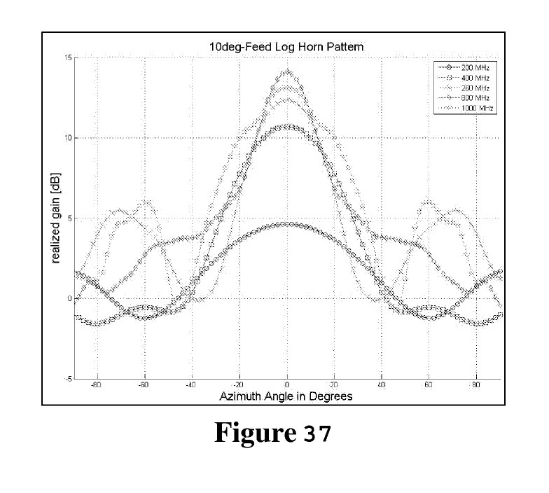

By analyzing the feed reflections from the tangentially fed Log-Horn antenna, it was clear that the antenna impedance was mismatched largely because the impedance at the feed was much lower than the 100Ω necessary to match the feeding network of vector network analyzer and hybrid. To increase the impedance of horn antenna, the angle between the conducing plates can be opened. Since the points of diffraction for the energy radiated will be moved farther apart from each other, the E-plane pattern should also be narrowed significantly by this modification. After simulating a few different opening angles, an angle of 10° was selected as shown in FIG. 36. The patterns appear quite similar with a few notable exceptions. The H-plane pattern is defined by the 15″ width of each antenna arm and the arm's taper toward the feed. Since this dimension was not changed, very small changes are detected in the H-plane patterns for the Log-Horn antenna with a 10° feed angle. E-plane patterns did narrow some due to the widening of the angle between the antenna arms for most frequencies. The notable exception is at 1000 (MHz). For all of the frequencies measured, it can be seen that the nulls and related side lobes have moved in toward the main lobe. In the case of 1000 (MHz), the first side lobe on either side has merged into the radiation region of the main lobe creating a wider main lobe in the E-plane than before the antenna modification. Again all of the E-plane plots can be seen in a single graph in FIG. 37.

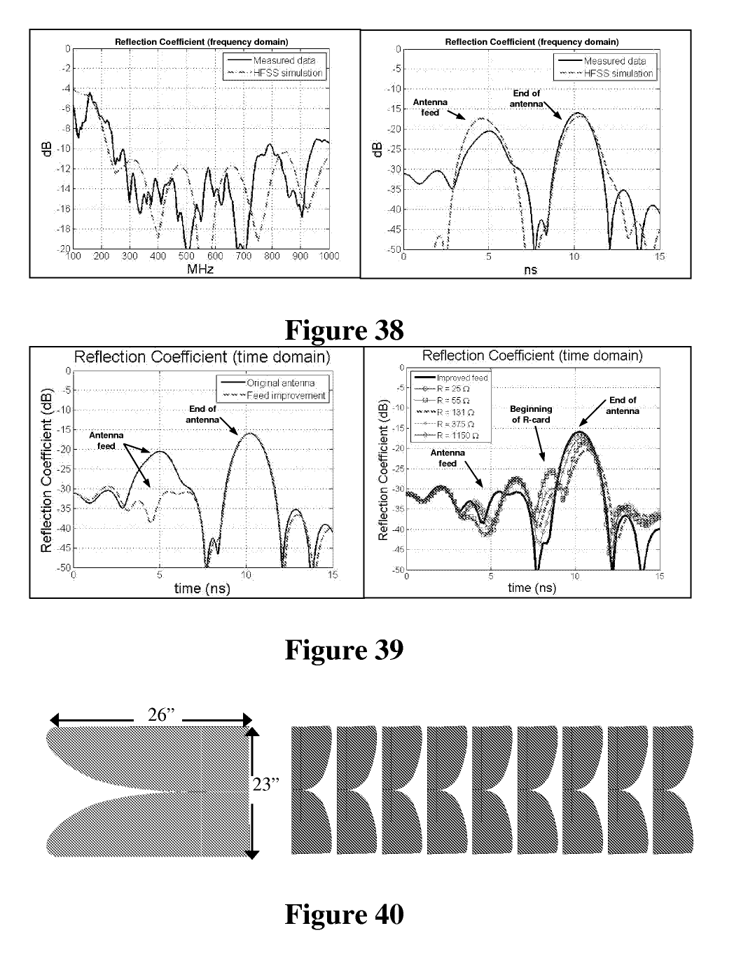

Since the main focus of the redesign was to reduce reflections by matching the antenna to the feeding network, a reexamination of the simulated and measured reflections was recorded as shown in FIG. 38. Again, the simulated and measured results were remarkably similar.

Since the hybrid was not modeled, there is a difference in the reflection before the antenna feed in the region 0-2 (ns). Likewise, after 13 (ns), there is a divergence since the simulation is done in free-space, and the actual measurement was done in a room with many scattering objects present. Since these levels are significantly below the feed reflection and antenna terms, they can be neglected. With the impedance characteristics of the antenna verified, a systematic approach to improving the antenna performance was undertaken. Opening up the feed angle reduced the reflection from −8 dB to −20 dB, additional improvement was realized by making minor physical adjustments to the constructed antenna. The end result of these modifications is shown in FIG. 39, with the improvement from the feed reflection reduced from −20 dB to below −30 dB. With the feed reflections reduced, the −16 dB reflections from the end of the antenna are the dominant source of reflections from the antenna.

The curvature of the horn arm plates creates discontinuities where the bend angle is large with respect to the wavelength of the radiating currents. Some current still reaches the ends of the antenna, especially at lower frequencies, which do not diffract along the horn arm curvature due to their large wavelengths. The remaining currents reflect back from the end of the antenna arm creating a standing wave. One technique to decrease the currents at the end of the antenna arms is to resistively load the copper conductor. FIG. 9 shows the experimental approach of resistive loading to decrease the reflections from the end of the antenna. Five values of R-card sheets were applied to the final 8″ of the interior side of each antenna arm. All five of the R-card values reduced the reflection from the end of the antenna. A small (−25 to −30 dB) reflection was also introduced 8″ from the end of the antenna where the conductor/R-card boundary begins. For the R-card value of 131Ω, the new reflection 8″ from the end of the antenna was the lowest, and the reflection from the end of the antenna at 10 ns was also reduced the most.

The Log-Horn antenna described was used for a number of field tests for detecting surface and sub-surface objects. After gaining some experience with the size and weight of the antenna, another approach was selected. By making use of the entire width of the vehicle, an array of thinner elements can be implemented to provide equal or improved performance. The array elements will also be lighter and more easily constructed improving field maintained and therefore actual performance in the field.

The array element selected is a variation on the Vivaldi-taper antenna as seen in FIG. 40. Like the previously constructed horn antenna, a curved surface is designed to create many discontinuities for the range of frequencies, which create diffraction. Since the antenna has a very small physical dimension along the diffraction edge, it is impossible to independently control the E-plane and H-plane patterns. A change in the curvature has an effect on the pattern in both planes. Since 12-16 of these elements will be arranged beside each other, the array factor will play a dominant role in the definition of the H-plane pattern. The antenna element curvature design focused mainly on the E-plane pattern. FIG. 40 shows the Vivaldi antenna element and a sample of an 8-element array.

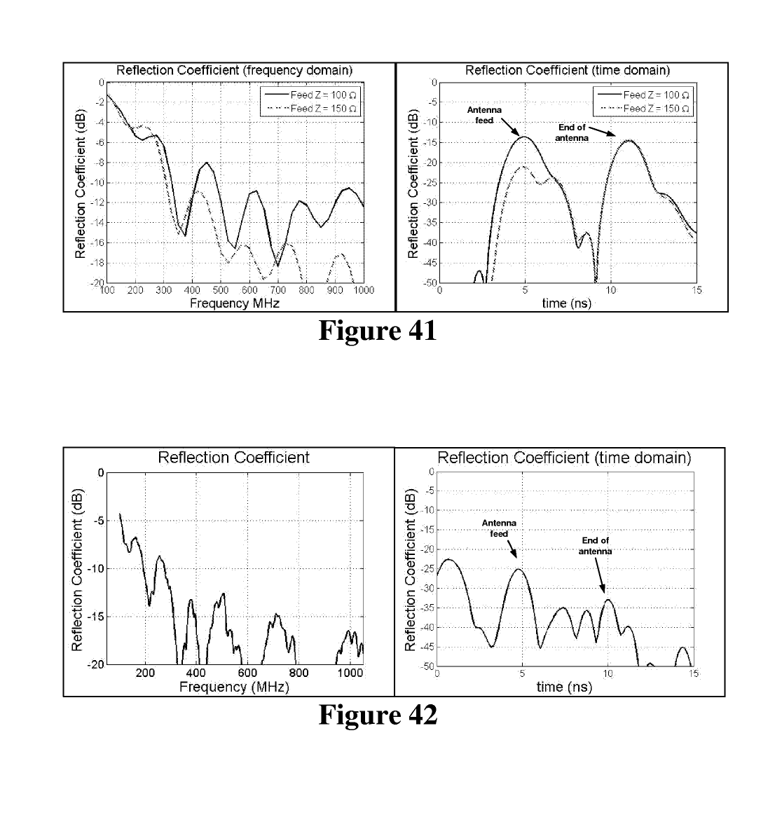

A Vivaldi element was designed using a modified geometry based on previously studied Vivaldi taper designs. This element was chosen for its stable pattern control over the frequency range of interest. Since the element is very thin in one dimension, it lends itself to being used in a 2-dimensional array. FIG. 41 shows the simulated reflection coefficient for this antenna element with a 100(Ω) and 150(Ω) feeding terminal.

After construction of the Vivaldi antenna, the contour was modified slightly so that the impedance would match more closely to the 100Ω feeding network as previously described. The frequency and time-domain measured values for the reflection coefficient can be seen in FIG. 42.

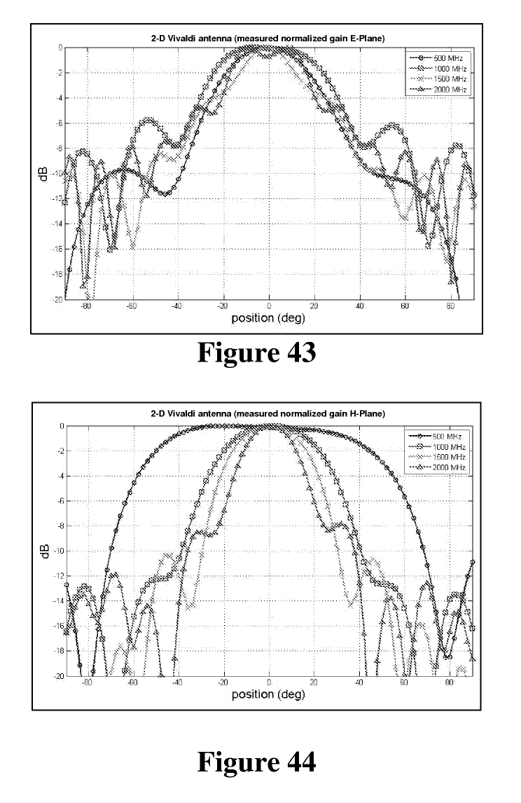

The reflection from the feed region of the antenna was reduced to −25 dB and the reflection from the end of the antenna was reduced to a very low level of −33 dB as seen in FIG. 42. After matching the antenna, E-plane and H-plane gain patterns were measured as seen FIG. 43 and FIG. 44.

FIG. 43 shows the E-plane patterns normalized to the peak gain value for that frequency. The E-plane has a very consistent beam width for a wide range of frequencies from 500 (MHz) to 2000 (MHz). At 2000 (MHz) there is a slight splitting of the main beam where the 0-deg position exhibits a −1 dB drop from the highest gain level at 8 (deg). For all frequencies, the side-lobe levels are reduced −6 to −10 dB.

The H-plane pattern is shown in FIG. 44. Here there is considerably more divergence. Especially since this beam will be narrowed by the array factor, a wide H-plane beam width is desired. The variation between 500-2000 (MHz) can make precise location of particular objects more difficult. In general, however, this single element pattern is quite reasonable for inclusion into a larger array.

The problems faced by forward-looking radar development can be separated into detection and identification of surface and buried objects. A typical object contains the buried object(s) itself, as well as the possibility of near surface disturbances. Current studies have been focused on studying the scattering, detection, and discrimination of a set of generic objects.

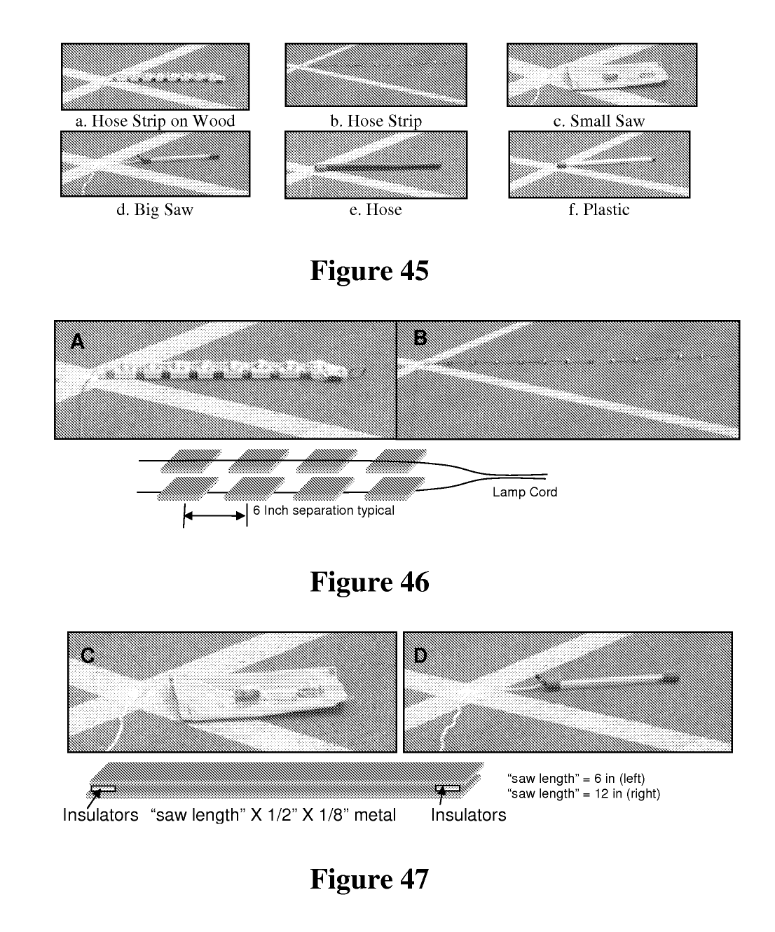

Six typical roadway impediments have been constructed for study and can be seen in FIG. 45. The scattering property of each of these objects has been examined in free space and on ground for its strength, polarity and EM resonance characteristics via both numerical modeling and experiments.

FIG. 46 shows the hose strips are created from multiple 1.5″ diameter sections of hose cut into 1″ sections. On either side of each hose section, a 1″×1″ square metallic structure is connected to one of a pair of conductors in a telephone cable. This hose-separated pair of conductors is repeated every 6 inches in the case of the hose strip, and every 2 inches in the case of the hose strip on wood.

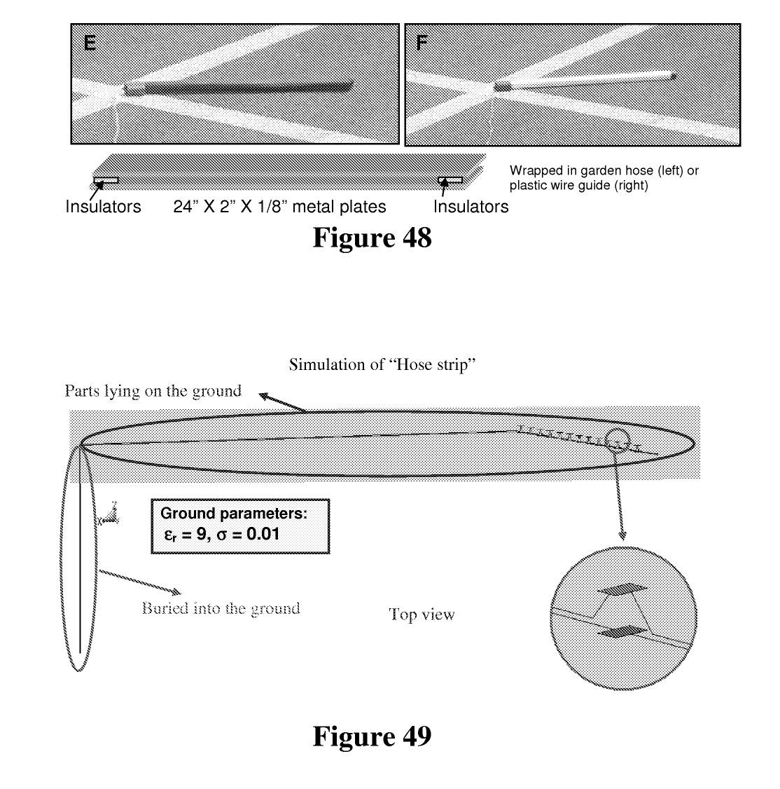

FIG. 47 shows the big saw is manufactured from two hacksaw blades measuring 12″×½″ which are placed parallel to each other with an air gap of 1″ between them. The 5′6 AWG wire is likewise connected to each of the saw blades. The small saw is created in the same way, but the saw blades are only 6″ in length. FIG. 48 show the hose and plastic encased conductors both contain parallel metallic plates 24″×1″ that are connected to the 5′6 AWG wire extending from the pressure switch. These conductive plates are then encased in a 24″ section of heavy-duty garden hose, or a plastic conduit. Numerical model simulations were performed using a commercial software package (FEKO). The physical dimensions from the objects presented previously gave a basis for this analysis. Each of the six objects has been simulated in a realistic orientation mounted on a ground surface of εᵣ=9 and σ=0.01 (S/m]. The objects themselves have been modeled in a simplistic form taking into account only the conducting structure. In FIG. 20 an example of the hose strip object is shown.

The orientation shown in FIG. 49 has the evenly spaced conductors of the object itself laid out in a cross-range orientation. The pair of conducting wires is placed diagonally from the end of the pressure switch 5′10″ and then terminated with a 2′ section of the same conducting wires buried vertically into the ground. This realistically represents a possible alignment providing the 5′10″ section of wire oriented so that currents may be induced by either horizontal or vertical electromagnetic waves propagating from an approaching vehicle.

Next, both objects were excited by a vertically polarized plane wave and the vertical component of the scattered field was measured to determine the RCS of each object. FIG. 21 shows the results of the numerical study for the big saw object and cylinder.

This study indicates that the RCS computed for the big saw has a maximum of 8×10⁻⁵ (m²) or −41 (dBsm), and the conductive cylinder maximum is in the range of 0.3 (m²) or −5 (dB) This data provides a benchmark for any physical radar system that can be calibrated against a conducting cylinder. For the case of this object, the radar dynamic range must be high enough to detect objects 36 [dB] below the scattered energy collected by a conductive cylinder at the same range.

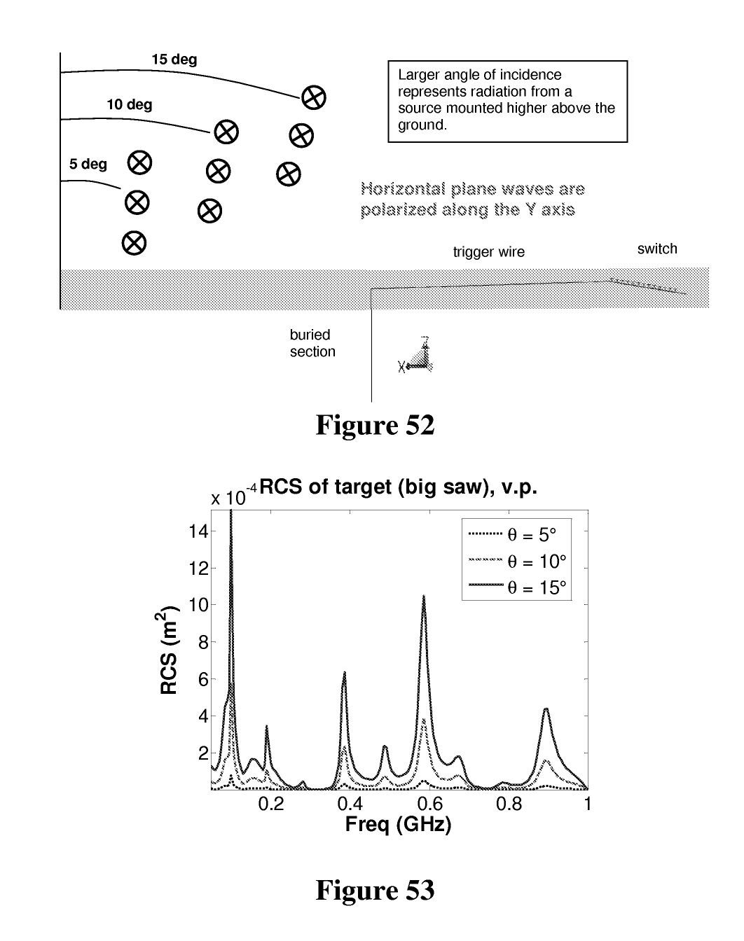

In order to simulate an antenna mounted directly on the ground facing the object, the simulated plane wave has an elevation angle of incidence defined as 0° with respect to the object. As antenna height increases, this angle of incidence will also necessarily increase. In this simulation, angles of 5°, 10°, and 15° were selected in order to demonstrate the trend of object RCS as transmitting antenna height is increased. A diagram of this is represented in FIG. 51 and FIG. 52. In a physical setting, at a range of 25′, at angles of 5°, 10° and 15° would correspond to mounted antenna heights of 2.2′, 4.4′ and 6.7′ respectively. The incident angles will be lower with antennas mounted at the same height at longer ranges; however, the trend provided from this study provides useful information for the general case.

FIG. 24 shows that the RCS increases across the spectrum analyzed as the incident angle of the plane wave increases. For each increase in angle between 5° and 15°, roughly 5 [dB] RCS gain is realized. It is also notable that the resonance signature is unchanged as the incident angle of the plane wave increases, which is important when classifying objects or integrating a number of measurements at different distances.

While the larger RCS or the pressure switch as height is increased is important data, several factors are important to consider when selecting mounting height for the on-vehicle antennas. The response from ground clutter and the ability to integrate measurements effectively while a vehicle is in motion are considered along with object RCS to determine an optimal system. A more detailed discussion of this optimization is offered in Chapter 3.

Horizontally polarized incident wave should excite a larger scattered response for objects lying perpendicular to the direction of travel. However, the ground creates a negating reflection of the horizontally polarized scattered field from the air/roadway interface. A vertically polarized scattered field is aided somewhat by this ground effect since the reflection from the air/roadway interface is in phase with the scattering from the object.

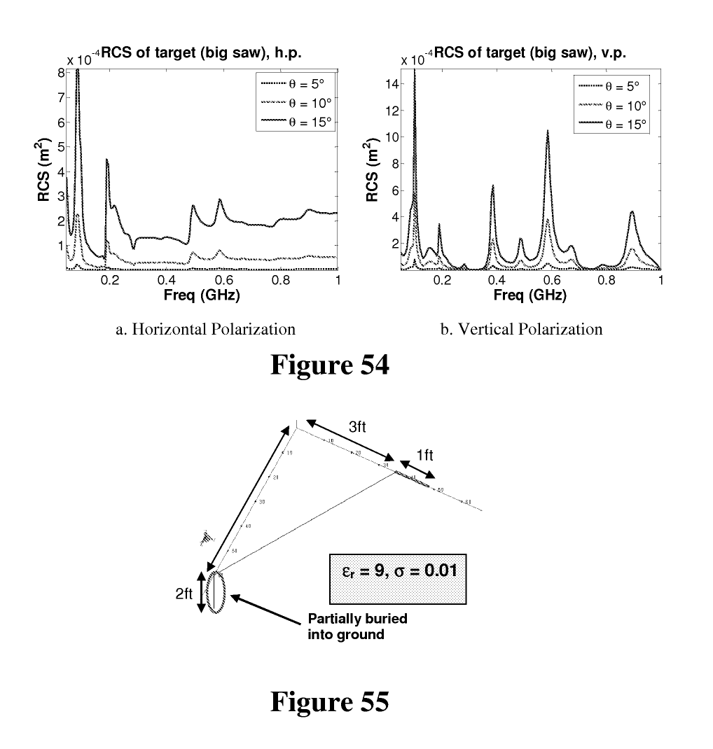

The previous study was repeated for both horizontally and vertically polarized incident fields. In each case, the scattered field with the same polarity as the incident field was measured. In FIG. 54 the result for this polarization study shows that a vertically polarized incident field yields higher RCS values for all incident angles. The RCS values are roughly doubled (+3 [dB]) for the highest resonant frequency when vertical polarization is used. In this case it is valuable to notice that the resonant peaks are not identical in the horizontal and vertical case. This is an expected behavior since in each case the induced currents which produce the radiated field, are induced in different portions of the geometry. Some of the benefits of understanding this resonance phenomenon are discussed in the next section

As displayed in FIG. 55 some object will have a portion of the object that is positioned down-range from the approaching vehicle and the main portion of the switch, which is placed across the direction of travel of the vehicle to maximize the chance of vehicle detection. Each of these components provides information to a radar system in terms of resonant frequencies, RCS levels, and polarization variations. To have the most accurate simulation, the layout shown in FIG. 55 was used.

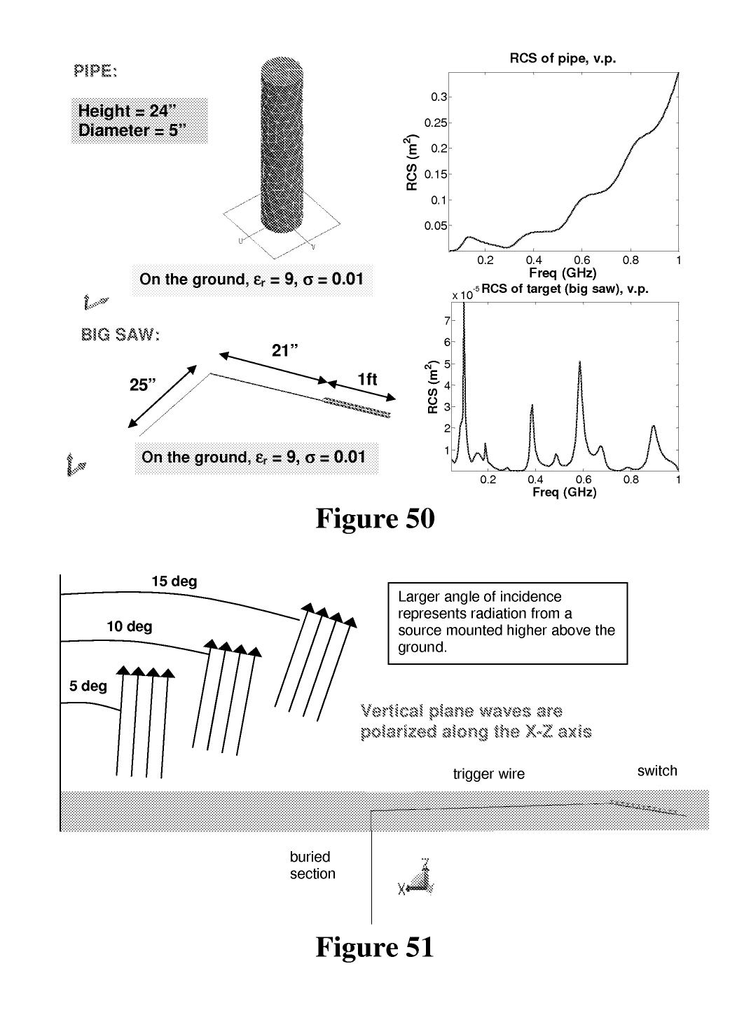

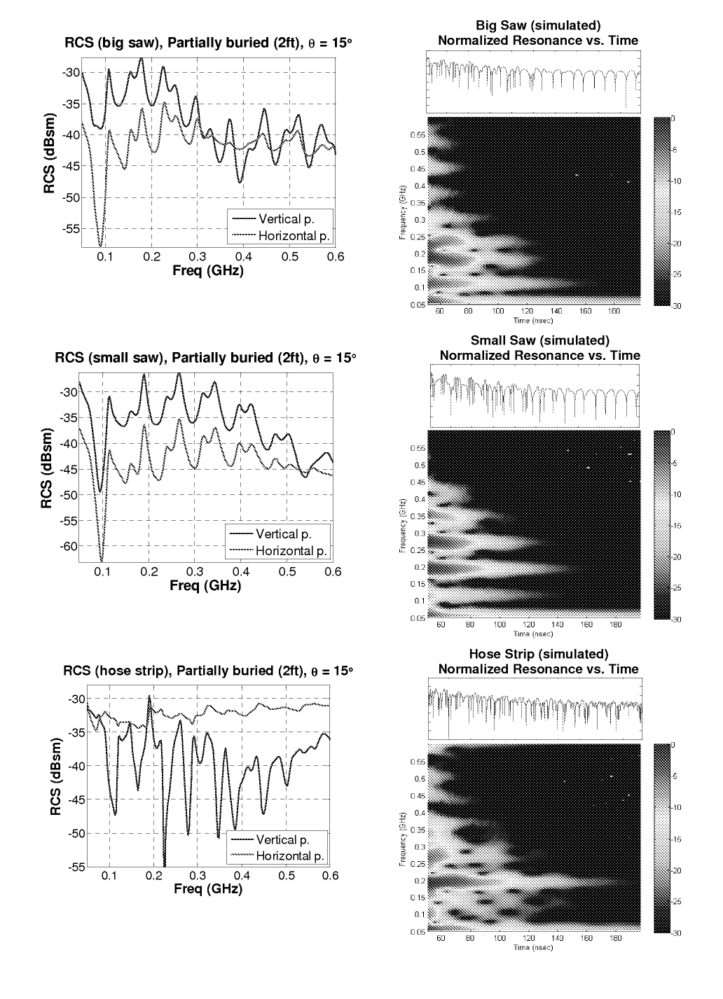

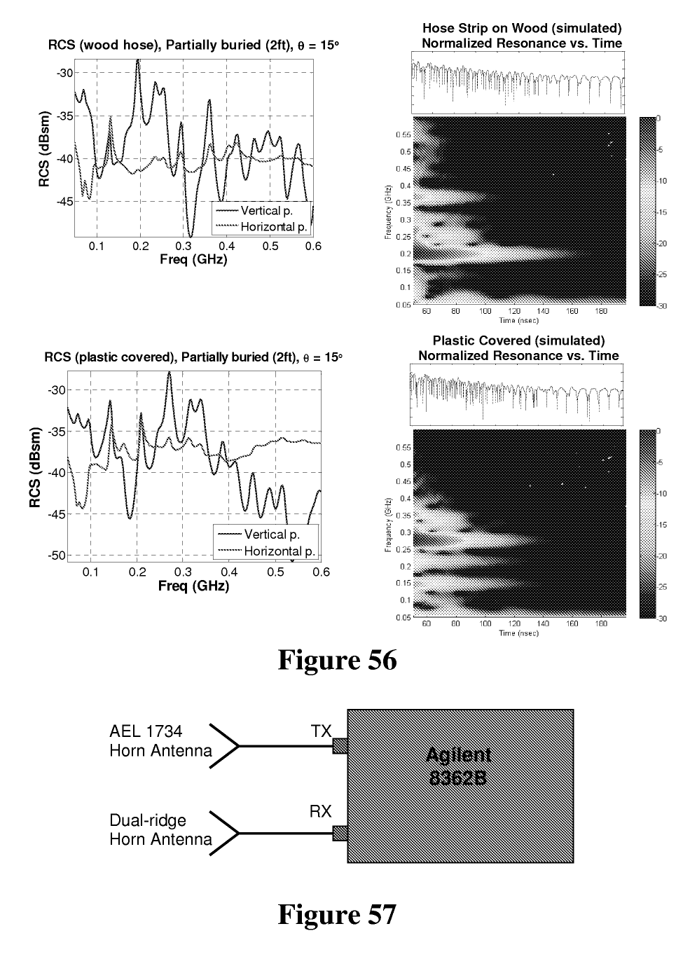

In FIG. 56 the unique H-H or V-V characteristics for a pair of objects can be seen. These complex resonances characterized by these two common object designs differentiate them from each other and from surrounding clutter. The vertical portion of the object combined with the transverse orientation of the object and buried section of wire create multiple resonances at different frequencies. The RCS of the conductive cylinder shown in FIG. 50 shows that simple structures such as roadside light posts or trash cans do not have these complicated resonant signatures.

The six objects pictured in FIG. 45 were measured on an asphalt roadway surface to maximize radar detection capabilities, and classify the frequency response from the objects. For each measurement a background sweep was subtracted from the sweep with the object in the range. In the field of operation, this is unrealistic, but can be closely approximated by comparing measurements taken at similar ranges, averaging a number of measurements along a representative stretch of roadway, or even comparing newly measured data to a benchmark taken in the case of a safe, or “cleared” rout

For this purpose the vector network analyzer, Agilent 8362b, and two commercially available linearly-polarized horn antennas were selected as shown in FIG. 57.

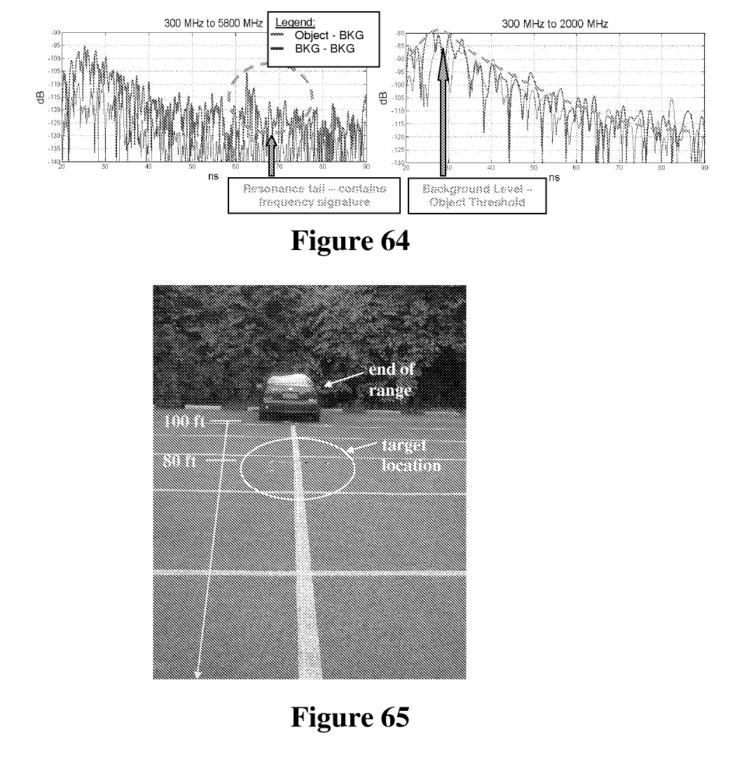

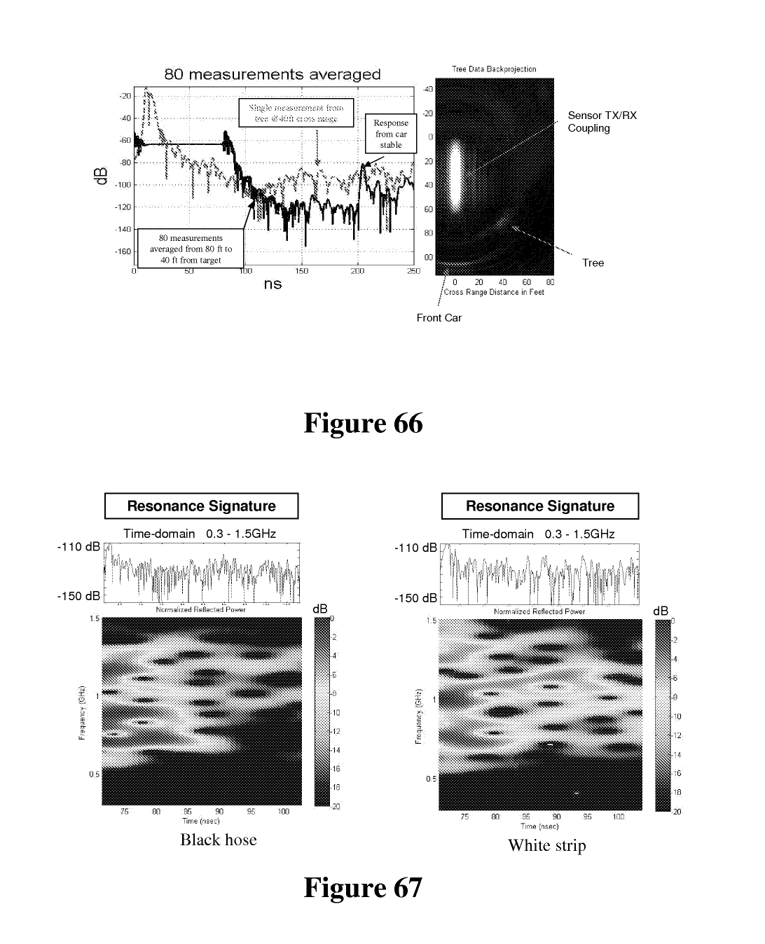

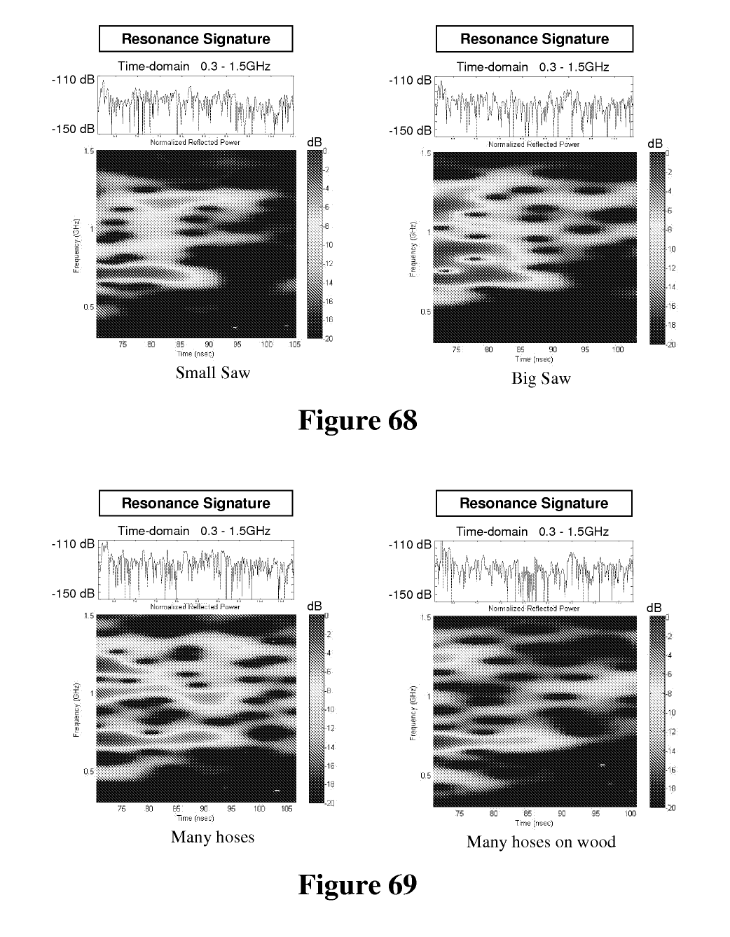

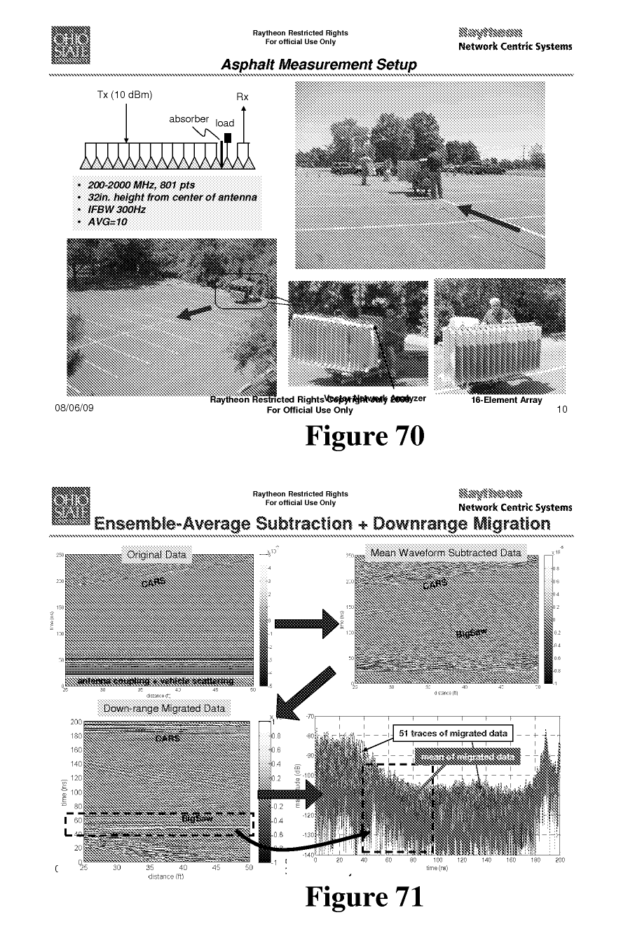

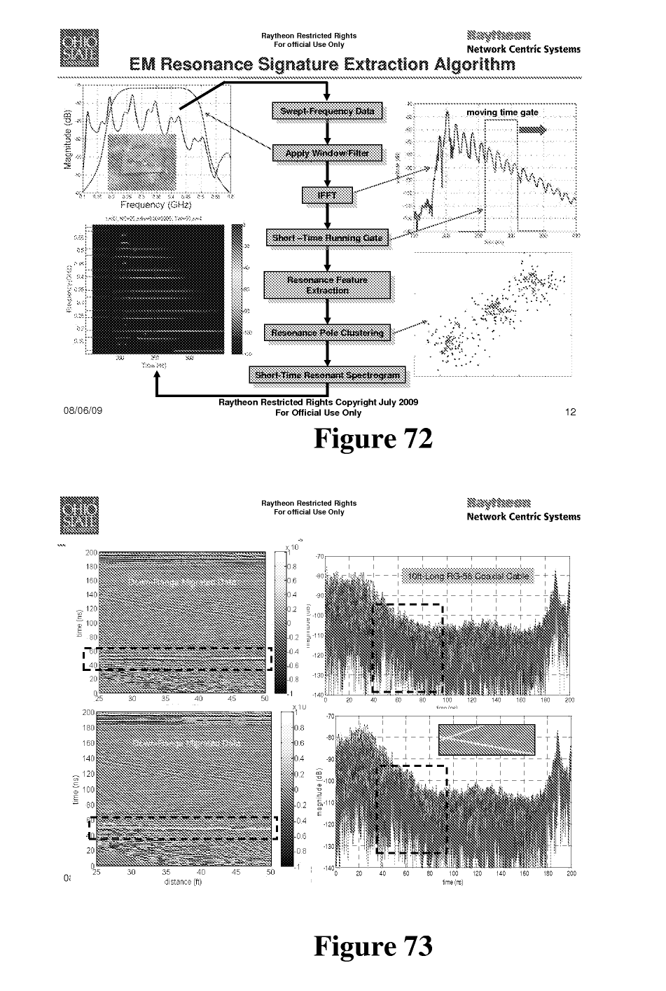

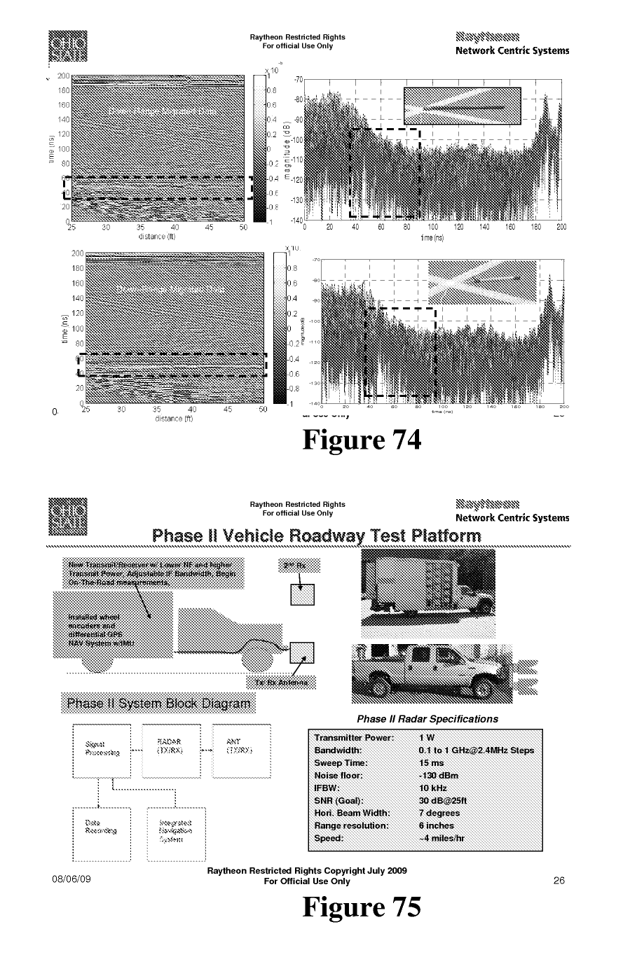

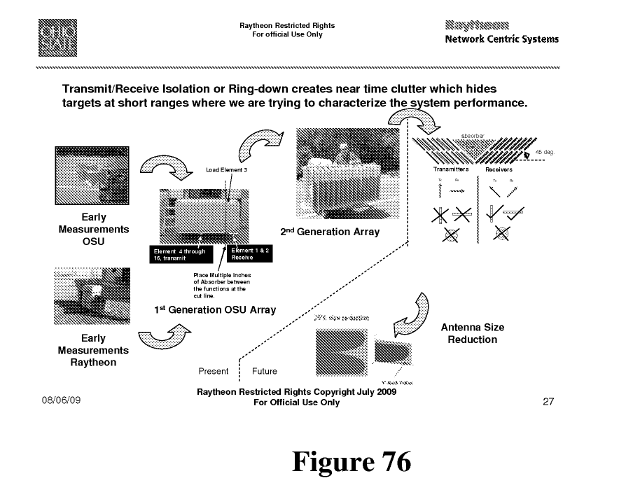

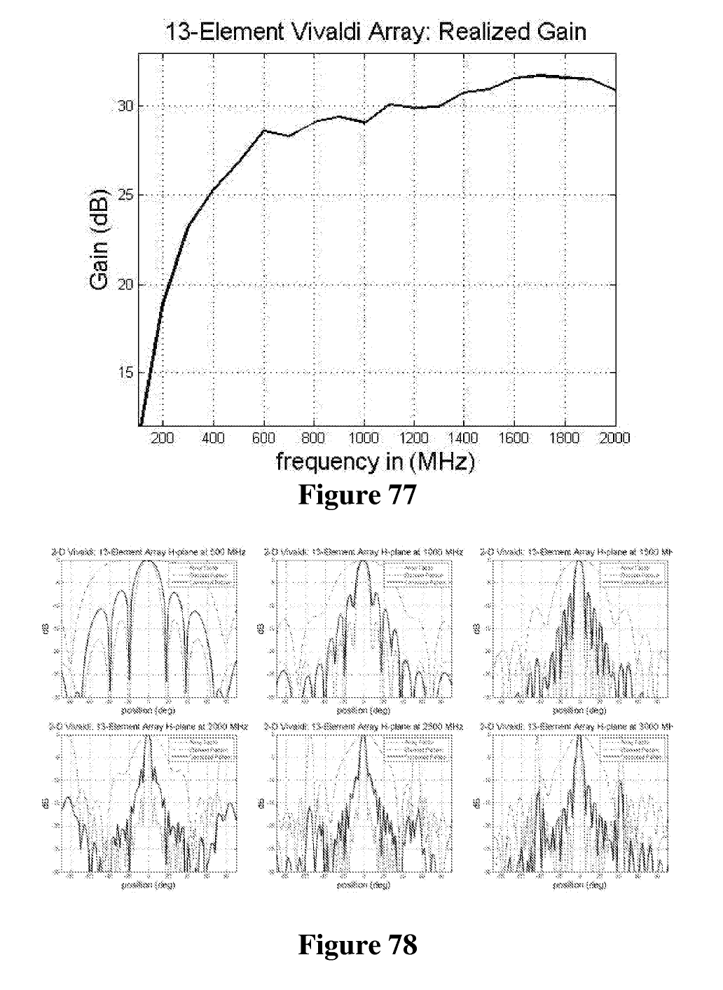

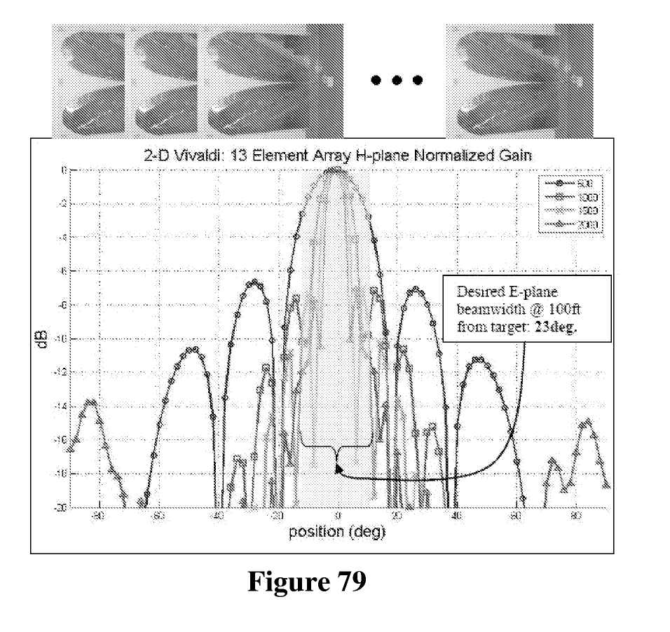

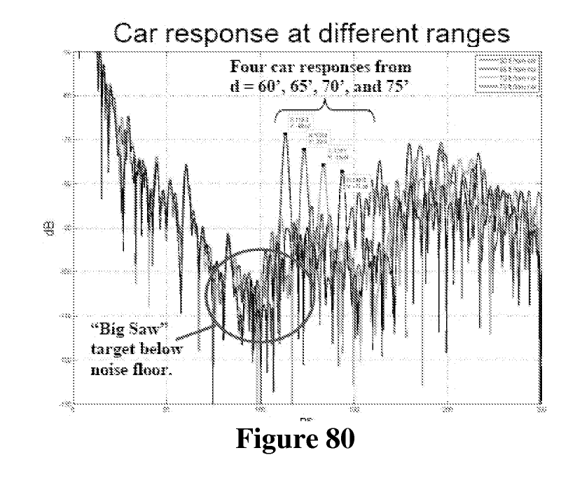

Since a wide range of frequencies is desired in order to classify detected objects, a stepped frequency and swept frequency radar were considered. The transmit power for the vector network analyzer (VNA) was limited to +5 (dBm) for output stability, and at this time no external amplification was used. The maximum signal detection and clutter suppression occurred over the frequency range 300 (MHz)-5800 (MHz) with 801 frequency points taken in order to give an unambiguous range 145.6 [ns]. Considering only the contribution from the free-space wave since the antennas and object are all above the roadway surface, this gives an unambiguous range of 72.8′. This is acceptable for a prototype system, but will have to be addressed when range needs to be increased. An IF bandwidth of 100 (Hz) was selected and with a total of 10 averages scanned, a time-domain noise floor of −125 (dB) is realized as displayed in FIG. 63-FIG. 67. Swept-Frequency showed no decrease in performance while speeding up the measurement process significantly and was therefore selected.

Radar Prototype

| Radar type | Swept-frequency | |
|---|---|---|
| Frequency range | 300-5800 | MHz |
| # of frequency points | 801 | |
| Tx power | +5 | dBm |
| IF bandwidth | 100 | Hz |

| | |
|---|---|
| # of averages | 10 |

The bi-static system selected has multiple degrees of freedom with respect to positioning of the transmit and receive antennas. The previous numerical studies showed that as the transmit antenna is raised in height and angled in the direction of an object the scattered response from the objects will increase. By the same principle, however, the clutter from a rough roadway surface will also give an increased response. Likewise, the receive antenna positioning can increase or decrease the amount of backscattering from the object or clutter will be detected. The antennas position relative to each other has an effect on the mutual coupling between the antennas. If the mutual coupling is strong, the background subtraction will not give the actual noise floor of the receiver. Although the early time mutual coupling can be reduced by time-gating, it is advantageous to limit the amount of coupling in the first place to provide the full capability of the radar to detect an object above the noise floor. In any case, the stability and predictability of this mutual coupling is necessary for any subtraction to yield an acceptable dynamic range for the system.

A wide range of transmit and receive antenna positions were considered using the entire practical geometry of a vehicle. Elevation positions from 0′-6′ and antenna proximity of 1′-8′ were considered. To verify the numerical data which showed that larger RCS values could be obtained by transmitting from a higher antenna, the 24″ cylinder was introduced to the test range and signal response was compared as the transmit antenna was moved to higher elevation. Numerical simulation showed the response of the cylinder to be +36 [dB] higher than that of the pressure objects. This test provided a more easily recognizable change as antenna height was increased. For each position, a pressure switch was also measured to be sure that the trend for increasing RCS was true for objects laying on the roadway surface.

As numerically predicted, the absolute response of both objects increased as antenna elevation increased, with the largest gains being between 0′-3′. Above 3′ in height, the scattering response from the objects increased more slowly. Clutter response also rose with increased antenna height. Between 0′-2′ there was little change, but above 2′ the clutter response began to increase more significantly. The optimal height for the largest possible signal-to-clutter ratio is between 2′-3′ in height as shown in FIG. 31.

While the transmit antenna was being raised, the receive antenna was also moved to a variety of positions above, below, or along side the transmit antenna. In each case, the scattered signal response was greatest when the receive antenna was at the same height as the transmit antenna. The mutual coupling was also observed and optimized by positioning the receive antenna at 21″ away from the transmit antenna as seen in FIG. 31.

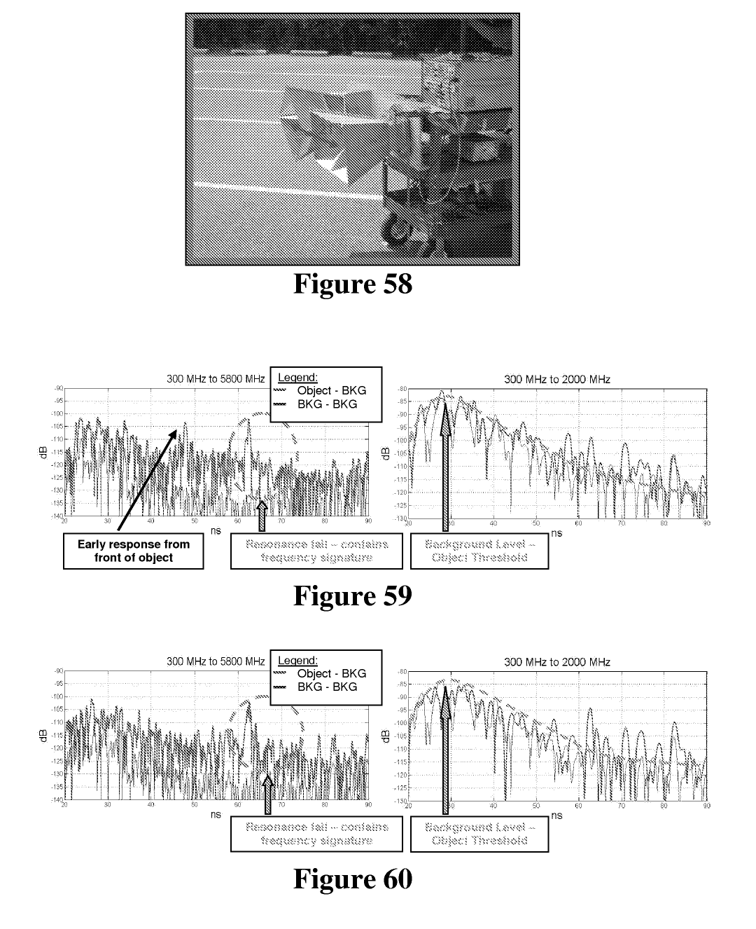

An asphalt parking lot with random surface irregularities was selected as a test site. Once the radar design and antenna configuration were defined, the system was mounted on a rolling cart as seen in FIG. 58. The objects were placed at 25′ down-range from the cart.

The test range was relatively flat, but contains some depressions due to the previous location of parked cars. The radar system's response to these variations is significant

Radar measurements focus on detection and classification of the surface objects. In this instance, the entire frequency range of 300-5800 MHz is considered. Lower frequencies would be useful for detecting objects below the roadway surface and show likely resonant structures with dimensions between 3-10 feet in free-space. With the system currently in use, the 300 MHz represents a lower frequency range that gives directional information about the object and reasonable resonant information. The upper end of the measured frequency spectrum was limited by the time of a measurement frequency sweep. The 300-5800 MHz stepped-frequency sweep took 4-5 seconds for a single sweep and commercially available radar systems should complete this scan in significantly less time.

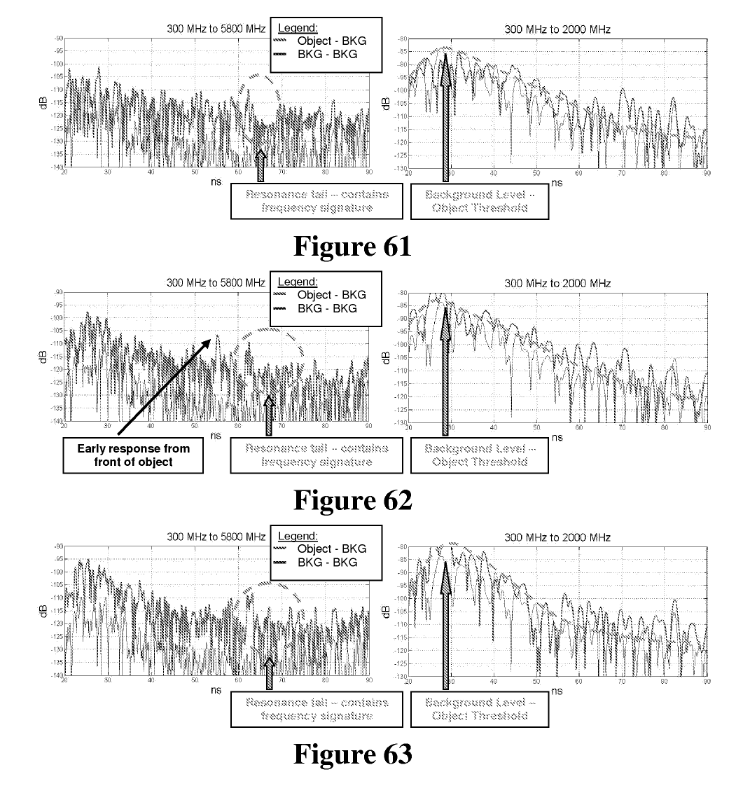

FIG. 59-FIG. 64 show the measurement data in several useful formats for each of the six objects measured on an asphalt roadway at a range of 25 feet. The Time-domain plot that makes use of the 300-5800 MHz frequency range is the most useful for detection. For each of the six objects, a signal that is 10-20 dB above the noise floor can be seen at 63 ns. A secondary peak can be seen at several nanoseconds earlier in FIG. 59 and FIG. 62. This peak indicates a location roughly 4 feet in front of the object, which corresponds to the end of the vertical section. Both of these peaks are useful for detecting an object.

The frequency-domain 300-5800 MHz plots shown in FIG. 59-FIG. 63 show that a noise floor of −100 dB is desired for as much of the frequency range as possible is desirable where the 0 dB plotted value represents +5 dBm transmitted power.

The lower portion of the frequency spectrum collected gives the multiple resonance information used for object detection. The 300-2000 (MHz) time-domain plots shown in FIG. 60-FIG. 63 show that detection is still possible in the lower frequency range. The dashed green line in these plots shows the general trend of the background data and the object measurement clearly stands above this trend-line at points where the object creates a field disturbance. With reduced frequency spectrum, however, it is more difficult to determine the precise location in time of the object signal.

By plotting frequency vs. time, it is shown that the radiated power from the object is emitted by currents flowing on conducting structures that are more complicated than typical roadside clutter. The complicated resonance structures shown indicate higher order resonances from the long wire sections and higher frequency resonance indicating physically smaller resonators. By classifying categories of these resonance responses for probable objects and common roadside clutter objects, an accurate determination can be made regarding the probability that a detected object is an object of interest or roadside clutter.

Tests were performed using a single antenna system attached to a moving cart. This system shows the signal processing advantages of near-earth mounting of Tx-Rx antennas. The signal processing gain is realized because objects directly in front of a moving vehicle will approach the vehicle at an identical rate to the vehicle movement while objects alongside the road will approach at a much slower rate.

In this field test, an automobile was located at the end of an asphalt paved roadway. The “Big Saw” object was placed at a position 20 feet from the vehicle marking the end of the roadway and 80 feet from the initial position of the measurement cart. The positioning of the objects can be seen in FIG. 65. A roadside tree (not shown in the figure) was also present at a down-range position of 75 feet and cross-range position 40 feet to the left of the center of the roadway. After the initial measurement, the radar system was moved forward 6 inches and another measurement was taken. This process was repeated 80 times until the radar measurement cart was at a new position 40 feet from the object and 60 feet from the automobile at the end of the range. An actual vehicle outfitted with this radar system will collect a very similar data set as it drives along a road.

If a radar system's antennas were mounted several feet in the air, stationary objects near to the vehicle would approach the radar's antennas much more slowly than objects farther away since the antenna height would be the dominant factor in determining distance between the vehicle and the object. In this experiment, the single Tx/Rx antenna was mounted very near the ground. The distance between the radar system and any stationary objects along the direct path of the vehicle will change at a rate equal to the movement of the radar system. The commonly know properties of the Fourier transform define the relationship between any two measurements taken as a radar system approaches objects directly down range:

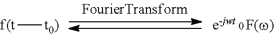

In this case (t-t₀) is equal to the amount of time it takes for the electromagnetic wave to travel from the Tx antenna to the object plus the time of the return trip from the object to the Rx antenna.

t₀=2 d/c

d=0.5 ft

c=984,251,969 ft/sec

t₀ 1.016×10⁻⁹

After multiplying the correct time shifting phase correction to each set of frequency data, the data can be averaged. By averaging 80 sets of data, the noise from the receiver is decreased while actual signal response for objects remains the same greatly increasing the systems signal-to-noise ratio. The distance to objects not directly down range from the direction of travel changes by a value less than that determined by the travel distance of the radar. By correcting for objects along the road, roadside objects can be suppressed from the data set. Roadside objects can also be focused by computing a distance correction factor for objects at a cross range distance from the direction of travel. FIG. 40 shows how a single measurement can be integrated 80 times along 40 feet of roadway to suppress the response of all objects outside of the down-range path of the radar system. The second plot in FIG. 40 shows how focusing each cross-range distance can determine the precise location of roadside objects.

A significant amount of processing gain can be realized because of the possible coherent integration of subsequent measurements at different positions along a road. The limiting factors to this coherent integration are the repeatability of the system conditions between measurements and the distance between the repeated measurements. This means that the speed of measurement is critical in order to make many RF sweeps in a short distance along the road.

The other major processing feature is the ability to classify potentially dangerous objects from benign roadside clutter. It is necessary to look at the complex frequency content of the reflected field of an object. In order to ignore mutual coupling of a bi-static radar, the early time returns should be ignored. In this way, the “late-time” response data can be examined.

Using the short-time Fourier transform (STFT) to analyze the data collected in the lower end of the frequency band shows the multiple resonances of the object response. The frequency vs. time plots shown in FIG. 41-FIG. 43 show the resonant “tails” from produced by the objects' induced currents. These plots utilize a 20 ns moving Hann window across the time region of the detected object. The windowed data is collected for a period of time after the detected object in order to view the decaying field produced by the resonating currents. The magnitude is represented by a color bar to give a visual representation of the resonance across the range of interest. The 2-D plot on top of figure represents the time-domain response of the object. The multi-colored plot below this plot shows relative amounts of frequency content from each signal.

By looking at the signatures of these objects, a system of intelligent differentiation can be designed into a data processing algorithm. It is less important to classify specific objects than to classify classes of objects. Common clutter along roadsides will have resonance structures with High-Q at a single frequency and its higher order mode.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A vehicle-mounted radar apparatus comprising:
at least one ultra-wide bandwidth radio wave transmitting antenna for transmitting radio waves in a traveling direction of a vehicle on which the radar apparatus is mounted;
at least one radio wave receiving antenna for receiving a radio wave reflected by the target;
an ultra-wide bandwidth transceiver unit adapted to send radio waves to the transmitting antenna and receive radio waves from the receiving antenna;
a data processing unit for receiving a signal from the radio wave receiving antenna, discerning a target to be detected from clutter, calculating a target angle and distance in front of the vehicle.

2. The radar apparatus of claim 1, wherein the at least one transmitting antenna is adapted to transmit a radio wave that is vertically polarized.

3. The radar apparatus of claim 1, wherein the at least one transmitting antenna is adapted to transmit a radio wave that is horizontally polarized.

4. The apparatus of claim 1, wherein the at least one transmitting antenna is adapted to transmit a radio wave that is both horizontally and vertically polarized.

5. The radar apparatus of claim 1 wherein the at least one transmitting antenna is adapted to transmit a lateral wave.

6. The radar apparatus of claim 1, wherein the apparatus is adapted to minimize ground waves.

7. The radar apparatus of claim 1, where in the at least one transmitting antenna is a directive antenna, with directive radiation pattern in the traveling direction to minimize ground waves.

8. The radar apparatus of claim 1 wherein the apparatus detects targets that include targets at the surface and subsurface region of a traveling surface, and subsurface media perturbations.

9. The radar apparatus of claim 8, wherein targets are detected in an area beginning substantially at the front of the vehicle and extending outward in the traveling direction.

10. The radar apparatus of claim 9 wherein the at least one transmitting antenna is adapted to transmit a lateral wave.

11. The apparatus of claim 10, wherein the apparatus detects targets by lateral wave detection.

12. The radar apparatus of claim 11, where in the at least one transmitting antenna is a directive antenna, with directive radiation pattern in the traveling direction to minimize ground waves.

13. The apparatus of claim 12, wherein the at least one transmitting antenna is adapted to transmit a radio wave that is both horizontally and vertically polarized.

14. The radar apparatus of claim 13, wherein the apparatus is adapted to minimize ground waves.

15. The radar apparatus of claim 1, wherein the at least one transmitting antenna is positioned near the traveling surface on a vehicle primarily suited for ground travel.

16. The radar apparatus of claim 15, wherein the apparatus comprises a first receiving antenna positioned at the same height as the at least one transmitting antenna, and a second receiving antenna positioned at a height above the first receiving antenna.

17. The radar apparatus of claim 16, where in the at least one transmitting antenna is a directive antenna, with directive radiation pattern in the traveling direction to minimize ground waves.

18. The apparatus of claim 17, wherein the at least one transmitting antenna is adapted to transmit a radio wave that is both horizontally and vertically polarized.

19. The radar apparatus of claim 18, wherein the apparatus is adapted to minimize ground waves.
